(19) United States
(12) Patent Application Publication
(10) Pub. No.: US 2026/0279835 A1
(43) Pub. Date: Sep. 17, 2026

(54) ANODES FOR LITHIUM-BASED ENERGY STORAGE DEVICES

(71) Applicant: Graphenix Development, Inc., Williamsville, NY (US)

(72) Inventors: Peter Symons, Williamsville, NY (US); Alexander J. Warren, Williamsville, NY (US); John C. Brewer, Williamsville, NY (US); Kyle P. Povlock, Williamsville, NY (US)

(73) Assignee: Graphenix Development, Inc., Williamsville, NY (US)

(21) Appl. No.: 18/872,014

(22) PCT Filed: Jun. 2, 2023
(86) PCT No.: PCT/US2023/024254

§ 371 Date: Dec. 5, 2024

Related U.S. Application Data
(60) Provisional application No. 63/351,152, filed on Jun. 10, 2022.

(51) Int. Cl. H01M 4/66; H01G 11/06; H01G 11/30; H01G 11/66; H01G 11/74; H01M 4/02; H01M 4/04; H01M 4/74; H01M 10/0525

(52) U.S. Cl. CPC H01M 4/667; H01G 11/06; H01G 11/30; H01G 11/66; H01G 11/74; H01M 4/0445; H01M 4/661; H01M 4/663; H01M 4/664; H01M 4/74; H01M 10/0525; H01M 2004/021; H01M 2004/027

(57) ABSTRACT

An anode for an energy storage device includes a current collector having an electrically conductive layer and a surface layer disposed over the electrically conductive layer. The surface layer may include a silicate compound. A lithium storage layer overlays and contacts the surface layer. The lithium storage layer may include at least 40 atomic % silicon, germanium, or a combination thereof. The lithium storage layer may be a continuous porous lithium storage layer.

### CROSS-REFERENCES TO RELATED APPLICATIONS

This application claims the benefit of priority of U.S. Provisional Application No. 63/351,152 filed Jun. 10, 2022, the entire contents of which is incorporated by reference in its entirety for all purposes.

### TECHNICAL FIELD

The present disclosure relates to lithium-ion batteries and related energy storage devices.

### BACKGROUND

Silicon has been proposed for lithium-ion batteries to replace the conventional carbon-based anodes, which have a storage capacity that is limited to ~370 mAh/g. Silicon readily alloys with lithium and has a much higher theoretical storage capacity (~3600 to 4200 mAh/g at room temperature) than carbon anodes. However, insertion and extraction of lithium into the silicon matrix causes significant volume expansion (>300%) and contraction. This can result in rapid pulverization of the silicon into small particles and electrical disconnection from the current collector.

The industry has recently turned its attention to nano- or micro-structured silicon to reduce the pulverization problem, i.e., silicon in the form of spaced apart nano- or micro-wires, tubes, pillars, particles, and the like. The theory is that making the structures nano-sized avoids crack propagation and spacing them apart allows more room for volume expansion, thereby enabling the silicon to absorb lithium with reduced stresses and improved stability compared to, for example, macroscopic layers of bulk silicon.

Despite research into various approaches, batteries based primarily on silicon have yet to make a large market impact due to unresolved problems.

### SUMMARY

There remains a desire for anodes for lithium-based energy storage devices such as Li-ion batteries that are easy to manufacture, robust to handling, high in charge capacity amenable to fast charging, for example, at least 1C, and have good cycle life.

In accordance with an embodiment of this disclosure, an anode for an energy storage device includes a current collector having an electrically conductive layer and a surface layer disposed over the electrically conductive layer. The surface layer may include a silicate compound. A lithium storage layer overlays and contacts the surface layer. The lithium storage layer may include at least 40 atomic % silicon, germanium, or a combination thereof. The lithium storage layer may be a continuous porous lithium storage layer. The energy storage device may be a lithium-ion battery.

In accordance with another embodiment of this disclosure, a current collector for a lithium-ion energy storage device is provided. The current collector may include an electrically conductive layer and a surface layer disposed over the electrically conductive layer. The surface layer may include a silicate compound.

In accordance with another embodiment of this disclosure, a method of making a current collector for use in an energy storage device is provided. A current collector precursor may include an electrically conductive layer. The method may include contacting the current collector precursor with an aqueous silicate mixture including silicic acid or a silicate salt to form the current collector having a surface layer containing a silicate compound.

In accordance with another embodiment of this disclosure, a method of making an anode for use in an energy storage device is provided. The method may include forming, by chemical vapor deposition using a silicon precursor gas, a lithium storage layer disposed over a current collector. The current collector may include a surface layer containing a silicate compound.

Many silicate compounds of the present disclosure are generally widely available, easy to handle, and have low toxicity. Compared to conventional surface layers, e.g., those that may use chromate, silicate-containing surface layers may provide lower manufacturing cost and improved health, safety, and environmental properties. The present disclosure provides anodes for energy storage devices that may have one or more of at least the following additional advantages relative to conventional anodes: improved stability at aggressive ≥1C charging and/or discharging rates; higher overall areal charge capacity; higher charge capacity per gram of lithium storage material (e.g., silicon); improved physical durability; simplified manufacturing process; more reproducible manufacturing process; or reduced dimensional changes during operation.

### BRIEF DESCRIPTION OF DRAWINGS

FIG. 1 is a cross-sectional view of a non-limiting example of an anode according to some embodiments.

FIG. 2 is a cross-sectional view of a prior art anode.

FIG. 3 is a cross-sectional view of a non-limiting example of an anode according to some embodiments.

FIG. 4 is a cross-sectional view of a non-limiting example of an anode according to some embodiments.

FIG. 5A is a cross-sectional schematic view of a non-limiting example of a current collector having first-type nanopillars according to some embodiments.

FIG. 5B is a cross-sectional schematic view of a non-limiting example of a current collector having second-type nanopillars according to some embodiments.

FIG. 6A is an SEM cross-sectional view of a non-limiting example of a current collector having nanopillar or nodular roughening features according to some embodiments.

FIG. 6B is an SEM cross-sectional view of a non-limiting example of a current collector having nanopillar or nodular roughening features according to some embodiments.

FIG. 7 is an SEM cross-sectional view of a non-limiting example of a current collector having broad roughness features according to some embodiments.

FIG. 8 is an SEM of a non-limiting example of a surface of a current collector that has been chemically roughened according to some embodiments.

FIG. 9 is a cross-sectional view of a non-limiting example of an anode according to some embodiments.

FIG. 10 is an SEM of Copper Foil C.

### DETAILED DESCRIPTION

It is to be understood that the drawings are for purposes of illustrating the concepts of the disclosure and may not be to scale. Terms like “overlaying”, “over” or the like include, but do not necessarily require, direct contact (unless such direct contact is noted or clearly required for functionality).

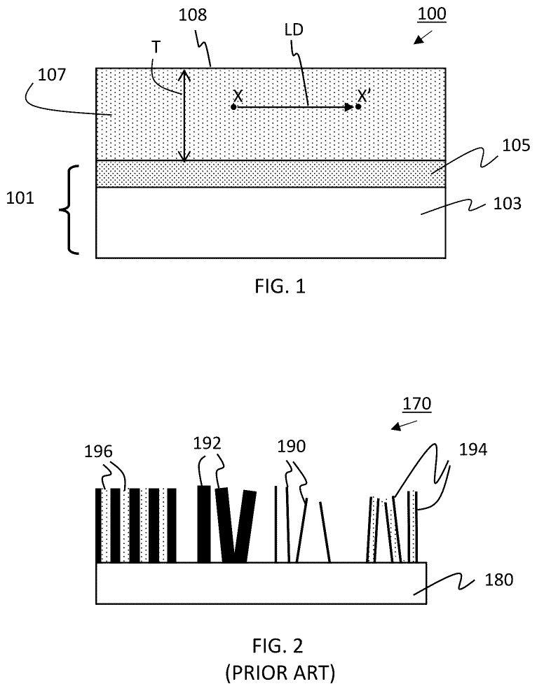

FIG. 1 is a cross-sectional view of an anode according to some embodiments of the present disclosure. Anode 100 includes current collector 101 and a lithium storage layer 107 overlaying the current collector. Current collector 101 includes a surface layer 105 provided over an electrically conductive layer 103, for example, an electrically conductive metal layer. Although the figure shows the surface of the current collector as flat for convenience, the current collector may have a rough surface as discussed below. The lithium storage layer 107 is provided over surface layer 105. In some embodiments, the top of the lithium storage layer 107 corresponds to a top surface 108 of anode 100. In some embodiments the lithium storage layer 107 is in physical contact with the surface layer 105. In some embodiments the lithium storage layer includes a material capable of forming an electrochemically reversible alloy with lithium. In some embodiments, the lithium storage layer includes silicon, germanium, tin, or alloys thereof. In some embodiments the lithium storage layer comprises at least 40 atomic % silicon, germanium, or a combination thereof. In some embodiments, the lithium storage layer is provided by a physical vapor deposition (PVD) process, e.g., by sputtering or e-beam, or by a chemical vapor deposition (CVD) process including, but not limited to, hot-wire CVD or a plasma-enhanced chemical vapor deposition (PECVD). In some embodiments, lithium storage layer 107 may be a continuous porous lithium storage layer.

In the present disclosure, the lithium storage layer 107, such as a continuous porous lithium storage layer, is substantially free of high aspect ratio nanostructures, e.g., in the form of spaced-apart wires, pillars, tubes or the like, or in the form of regular, linear vertical channels extending through the lithium storage layer. FIG. 2 shows a cross-sectional view of a prior art anode 170 that includes some non-limiting examples of lithium storage nanostructures, such as nanowires 190, nanopillars 192, nanotubes 194 and nanochannels 196 provided over a current collector 180. Unless noted otherwise, the term “lithium storage nanostructure” herein generally refers to a lithium storage active material structure (for example, a structure of silicon, germanium, or their alloys) having at least one cross-sectional dimension that is less than about 2,000 nm, other than a dimension approximately normal to an underlying substrate (such as a layer thickness) and excluding dimensions caused by random pores and channels. Similarly, the terms “nanowires”, “nanopillars,” and “nanotubes” refers to wires, pillars, and tubes, respectively, at least a portion of which, have a diameter of less than 2,000 nm. “High aspect ratio” nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the lithium storage layer is considered “substantially free” of lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. In some embodiments, an anode may have patterned regions of lithium storage layer 107 and other regions that may purposefully include lithium storage nanostructures. In such cases, the term “substantially free” may refer just to the patterned regions of the lithium storage layer. As noted below, the current collector may have a high surface roughness or include nanostructures, but these features are separate from the lithium storage layer and not considered to be or induce lithium storage nanostructures.

In some embodiments, deposition conditions are selected in combination with the current collector so that the continuous porous lithium storage layer is relatively smooth providing an anode with diffuse or total reflectance of at least 10% at 550 nm, alternatively at least 20% (measured at the continuous porous lithium storage layer side). In some embodiments, anodes having such diffuse or total reflectance may be less prone to damage from physical handling. In some embodiments, anodes that are not substantially free of lithium storage nanostructure may have lower reflectance and may be more prone to damage from physical handling.

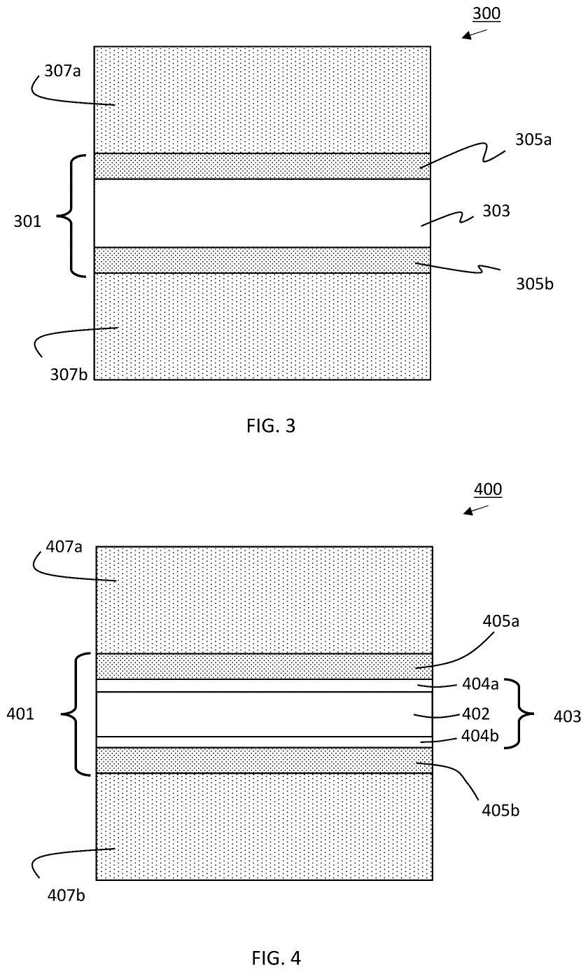

Anodes of the present disclosure may optionally be two-sided. For example, FIG. 3 is a cross-sectional view of a two-sided anode according to some embodiments. The current collector 301 may include electrically conductive layer 303 and surface layers (305a, 305b) provided on either side of the electrically conductive layer 303. Lithium storage layers (307a, 307b) are disposed on both sides to form anode 300. Surface layers 305a and 305b may be the same or different with respect to composition, thickness, roughness or some other property. Similarly, lithium storage layers 307a and 307b may be the same or different with respect to composition, thickness, porosity or some other property.

### Current Collector

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the surface layer. If the tensile strength is too high or too low, it may be difficult to handle in manufacturing such as in roll-to-roll processes. During electrochemical cycling of the anode, deformation of the anode may occur if the tensile strength is too low, or alternatively, adhesion of the lithium storage layer may be compromised if the tensile strength is too high.

Deformation of the anode is not necessarily a problem for all products, and such deformation may sometimes only occur at higher capacities, i.e., higher loadings of lithium storage layer material. For such products, the current collector or electrically conductive layer may be characterized by a tensile strength Rm in a range of 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, alternatively 1200-1500 MPa, or any combination of ranges thereof.

In some embodiments, significant anode deformation should be avoided, but low battery capacities may not be acceptable. For example, in some cases when the anode includes 7 μm or more of amorphous silicon and/or the electrochemical cycling capacity is 1.5 mAh/cm² or greater, a current collector or electrically conductive layer may be selected that is characterized by a tensile strength Rm of greater than 450 MPa, alternatively greater than 500 MPa, alternatively greater than 550 MPa or alternatively greater than 600 MPa. In such embodiments, the tensile strength may be in a range of about 450-500 MPa, alternatively 500-550 MPa, alternatively 550-600 MPa, alternatively 600-650 MPa, alternatively 650-700 MPa, alternatively 700-750 MPa, alternatively 750-800 MPa, alternatively 800-850 MPa, alternatively 850-900 MPa, alternatively 900-950 MPa, alternatively 950-1000 MPa, alternatively 1000-1200 MPa, alternatively 1200-1500 MPa, or any combination of ranges thereof. In some embodiments, the current collector or electrically conductive layer may have a tensile strength of greater than 1500 MPa. In some embodiments, the current collector or electrically conductive layer is in the form of a foil having a tensile strength of greater than 600 MPa and an average thickness in a range of 4-8 μm, alternatively 8-10 μm, alternatively 10-14 μm, alternatively 14-18 μm, alternatively 18-20 μm, alternatively 20-25 μm, alternatively 25-30 μm, alternatively 30-40 μm, alternatively 40-50 μm, or any combination of ranges thereof.

In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. For anodes having low capacity and/or where there are no concerns regarding anode deformation during use, a wide variety of conductive materials may be used as the electrically conductive layer. In some embodiments, the electrically conductive layer includes a metallic material, e.g., titanium (and its alloys), nickel (and its alloys), copper (and its alloys), or stainless steel. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil, a mesh, or sheet of conductive material. Herein, a “mesh” includes any electrically conductive structure having openings such as found in interwoven wires, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers.

When higher tensile strength is desirable, e.g., where Rₘ is greater than 450 MPa, alternatively greater than 500 MPa, alternatively greater than 550 MPa, or alternatively greater than 600 MPa, the electrically conductive layer may include nickel (and various alloys), or various copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous), CuNi3Si (an alloy primarily of copper, nickel, and silicon), CuCrZr (an alloy primarily of copper, chromium, and zirconium), and CuCrSiTi (an alloy primarily of copper, chromium, silicon, and titanium). The nomenclature for the metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

Alternatively, a mesh or sheet of electrically conductive carbon, including but not limited to, those formed from bundled carbon nanotubes or nanofibers, may in some cases provide for higher tensile strength electrically conductive layers. In some embodiments, an electrically conductive metal interlayer may be interposed between the electrically conductive carbon and the surface layer.

In some embodiments, any of the above-mentioned electrically conductive layers (low or high tensile strength) may act as a primary electrically conductive layer and further include an electrically conductive interlayer, e.g., a metal interlayer, disposed between the primary electrically conductive layer and the surface layer. FIG. 4 is a cross-sectional view of such an anode according to some embodiments, in this case, for a two-sided anode. The current collector 401 may include electrically conductive layer 403 and surface layers (405a, 405b) provided on either side of the electrically conductive layer 403. Lithium storage layers (407a, 407b) may be disposed on both sides to form anode 400. Electrically conductive layer 403 includes a primary electrically conductive layer 402 with metal interlayers (404a, 404b) provided on either side. Metal interlayers 404a and 404b may be the same or different with respect to composition, thickness, roughness, or some other property. Similarly, surface layers 405a and 405b may be the same or different with respect to composition, thickness, roughness or some other property. Similarly, lithium storage layers 407a and 407b may be the same or different with respect to composition, thickness, porosity, or some other property.

The metal interlayer may be applied by, e.g., by sputtering, vapor deposition, electrolytic plating, or electroless plating, or any convenient method. The metal interlayer generally has an average thickness of less than 50% of the average thickness of the total electrically conductive layer, i.e., the combined thickness of primary electrically conductive layer and metal interlayer(s). In some embodiments, the surface layer may form more uniformly over, or adhere better to, the metal interlayer than to the primary electrically conductive layer.

In some embodiments, the current collector may be characterized as having a surface roughness. In some embodiments, the top surface 108 of the lithium storage layer 107 may have a lower surface roughness than the surface roughness of current collector 101. Herein, surface roughness comparisons and measurements may be made using the Roughness Average (Rₐ), RMS Roughness (R_{q}), Maximum Profile Peak Height roughness (Rₚ), Average Maximum Height of the Profile (R_{z}), or Peak Density (P_{c}). In some embodiments, the current collector may be characterized as having both a surface roughness R_{z}≥2.5 μm and a surface roughness Rₐ≥0.25 μm. In some embodiments, R_{z} is in a range of 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10 μm, 10 to 12 μm, 12 to 14 μm or any combination of ranges thereof. In some embodiments, Rₐ is in a range of 0.25-0.30 μm, alternatively 0.30-0.35 μm, alternatively 0.35-0.40 μm, alternatively 0.40-0.45 μm, alternatively 0.45-0.50 μm, alternatively 0.50-0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, alternatively 1.0-1.2 μm, alternatively 1.2-1.4 μm, or any combination of ranges thereof.

In some embodiments, some or most of the surface roughness of the current collector may be imparted by the electrically conductive layer and/or a metal interlayer. Alternatively, some or most of the surface roughness of the current collector may be imparted by the surface layer. Alternatively, some combination of the electrically conductive layer, metal interlayer, and surface layer may contribute substantially to the surface roughness.

In some embodiments, the electrically conductive layer may include roughening features, e.g., electrodeposited roughening features, to increase surface roughness. In some embodiments, the electrodeposited roughening features may include copper features. For instance, a relatively smooth copper foil may be provided into a first acid copper plating solution having 50 to 250 g/L of sulfuric acid and less than 10 g/L copper provided as copper sulfate. Copper roughening features may be deposited at room temperature by cathodic polarization of the copper foil and applying a current density of about 0.05 to 0.3 A/cm² for a few seconds to a few minutes. In some embodiment, the copper foil may next be provided into a second acid copper plating solution having 50 to 200 g/L of sulfuric acid and greater than 50 g/L copper provided as copper sulfate. The second acid copper bath may optionally be warmed to temperature of about 30° C. to 50° C. A thin copper layer may be electroplated over the copper features to secure the particles to the copper foil by cathodic polarization and applying a current density of about 0.05 to 0.2 A/cm² for a few seconds to a few minutes.

Alternatively, or in combination with the roughening features, the electrically conductive layer may undergo another electrochemical, chemical or physical treatment to impart a desired surface roughness prior to formation of the surface layer.

In some embodiments, a metal foil, including but not limited to, a rolled copper foil, may be first heated in an oven in air (e.g., between 100° and 200° C.) for a period of time (e.g., from 10 minutes to 24 hours) remove any volatile materials on its surface and cause some surface oxidation. In some embodiments, the heat-treated foil may then be subjected to additional chemical treatments, e.g., immersion in a chemical etching agent such as an acid or a hydrogen peroxide/HCl solution optionally followed by deionized water rinse. The chemical etching agent removes oxidized metal. Such treatment may increase the surface roughness. In some embodiments, there is no heating, but a treatment with a chemical etching agent that includes an oxidant. In some embodiments, the oxidant may be dissolved oxygen, hydrogen peroxide, or some other appropriate oxidant. Such chemical etching agents may further include an organic acid such as methanesulfonic acid or an inorganic acid such as hydrochloric or sulfuric acid. A chemical etching agent may optionally be followed by deionized water rinse. Such treatments described in this paragraph may be referred to herein as “chemical roughening” treatments.

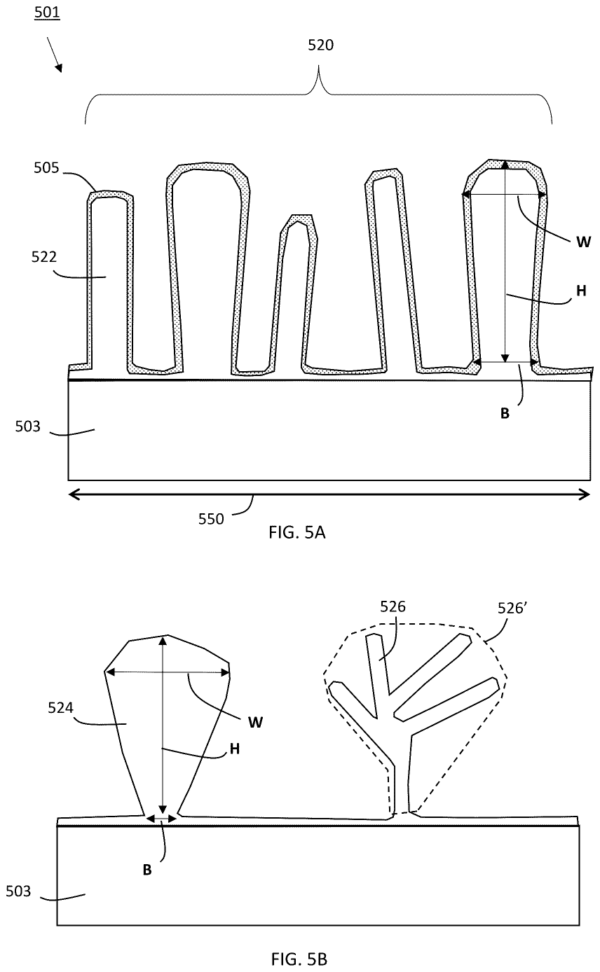

In some embodiments, the roughening features may be characterized as nanopillar features. FIG. 5A illustrates a cross-sectional view of a non-limiting example of electrodeposited copper roughening features according to some embodiments. In some cases, current collector 501 may include a plurality of nanopillar features 520 (electrodeposited copper roughening features) disposed over the electrically conductive layer 503. Nanopillar features 520 are distinguished from lithium storage nanopillars 192 of FIG. 2 at least by their compositions, their layers, their dimensions, the processes used to form the nanopillars, their surface densities, and/or their orientations. Nanopillar features 520 may include a metal-containing nanopillar core 522 (e.g., copper-containing core) and a surface layer 505 provided at least partially over the nanopillar core and optionally over the electrically conductive layer in interstitial areas between nanopillar features. The nanopillar features may each be characterized by a height H, a base width B, and a maximum width W. The base width B may be the minimum width across the bottom or base of the nanopillar feature. The maximum width W may be measured across the widest section orthogonal to the nanopillar feature axis. The height H may be measured from the base to the end of the nanopillar feature along the nanopillar feature axis. The nanopillar axis is the longitudinal axis of the nanopillar feature. In some cases, the nanopillar feature axis may pass through the center of mass of the nanopillar feature.

In some embodiments, nanopillar features may be characterized by a height H in a range of about 0.4 μm to 0.6 μm, alternatively 0.6 μm to 0.8 μm, alternatively 0.8 μm to 1.0 μm, 1.0 μm to 1.5 μm, alternatively 1.5 μm to 2 μm, alternatively 2 μm to 3 μm, alternatively 3 μm to 4 μm, alternatively 4 μm to 5 μm, or any combination of ranges thereof. In some embodiments, nanopillar features may be characterized by a maximum width W in a range of about 0.4 μm to 0.6 μm, alternatively 0.6 μm to 0.8 μm, alternatively 0.8 μm to 1.0 μm, 1.0 μm to 1.5 μm, alternatively 1.5 μm to 2 μm, alternatively 2 μm to 3 μm, or any combination of ranges thereof. In some cases, nanopillar features may be characterized by an aspect ratio H/W in a range of about 0.8 to 1.0, alternatively 1.0 to 1.5, alternatively 1.5 to 2.0, alternatively 2.0 to 2.5, alternatively 2.5 to 3, alternatively 3 to 4, alternatively 4 to 5, alternatively 5 to 6, alternatively 6 to 8, alternatively 6 to 10, or any combination of ranges thereof. In some embodiments, an average 10 μm by 10 μm surface of the electrically conductive layer may include at least 3 nanopillar features, alternatively at least 4, alternatively at least 5, alternatively at least 6, alternatively at least 7, alternatively at least 8, alternatively at least 9, alternatively at least 10.

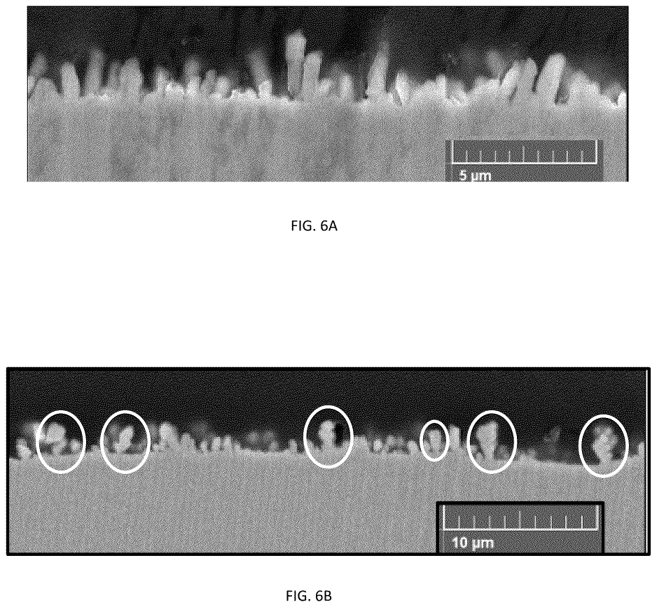

In some embodiments, nanopillar features may be characterized as first-type and second-type nanopillars. In some cases, first-type nanopillars may be characterized by: H in a range of 0.4 μm to 3.0 μm; B in a range of 0.2 μm to 1.0 μm; a W/B ratio in a range of 1 to 1.5; an H/B (aspect) ratio in a range of 0.8 to 4.0; and/or an angle of the longitudinal axis of the nanopillar feature to the plane of the electrically conductive layer in a range of 60° to 90°. For example, most or all of the nanopillar features in FIG. 5A may be first-type nanopillars. FIG. 6A is an SEM cross-section of a non-limiting example of a current collector having mostly first-type nanopillar features. In some embodiments, in an optical or SEM analysis, an average 20 μm long cross section of the current collector may include at least two (2) first-type nanopillars, alternatively at least 3, at least 4, at least 5, at least 6, at least 7, at least 8, or at least 10 first-type nanopillars. In some embodiments, in an optical or SEM analysis, an average 20 μm long cross section of the current collector may include 2-4 first-type nanopillars, alternatively 4-6, alternatively 6-8, alternatively 8-10, alternatively 10-12, alternatively 12-14, alternatively 14-16, alternatively 16-20, alternatively 20-25, alternatively 25-30, or any combination of ranges thereof. Note that the 20 μm length of analysis refers to a lateral distance 550 along the length of the current collector, for example, as indicated in FIG. 5A.

In some cases, second-type nanopillars may be characterized by H of at least 1.0 μm and a W/B ratio greater than 1.5. That is, second-type nanopillars tend to widen away from their base. FIG. 5B is a cross-sectional view of a non-limiting example of second-type nanopillars. For clarity the nanopillar core and surface layers are not separately defined. A second-type nanopillar may have a significantly wide upper portion (sometimes referred to herein as “wide-top roughening features”) such as nanopillar feature 524. Alternatively, a second-type nanopillar may include a branched or tree-like structure as in nanopillar feature 526. Although the “trunk” and “branches” are all similar in width, the feature overall is significantly wider toward the top as illustrated by effective cross section profile 526′. Effective cross section profile 526′ is a shape formed by lines drawn between the outermost points of consecutive branches or trunk of the nanopillar feature. Such branched structures may have the same effect as a solid nanopillar feature like 524.

FIG. 6B is an SEM cross-section of a non-limiting example of a current collector having some second-type nanopillars (circled). The performance of anodes having second-type nanopillars may be acceptable in many embodiments. However, in some embodiments, it has been observed that anodes having a large number of second-type nanopillars may occasionally be inferior relative to anodes having fewer second-type nanopillars. Not being bound by theory, it may be that the wide tops interfere with the roughening features from becoming embedded in the silicon. Alternatively, these structures may be structurally fragile and may break at the base. Regardless, current collectors having too many of such structures may in some embodiments not perform well with PECVD-deposited lithium storage materials. In some embodiments, in an optical or SEM analysis, an average 20 μm long cross section of the current collector may include fewer second-type nanopillars than first-type nanopillars. In some embodiments, in an optical or SEM analysis, an average 20 μm long cross section of the current collector may include fewer than ten (10), alternatively fewer than 9, fewer than 8, fewer than 7, fewer than 6, fewer than 6, fewer than 4, fewer than 3, fewer than 2, or fewer than 1 second-type nanopillar(s).

In some embodiments, the nanopillars may fall into a category other than first-type nanopillars or second-type nanopillars. In some embodiments, the roughening features may be characterized as nodular features, which may in some cases include particulate or hemispheroidal features. In some cases, nodular features may be electrodeposited roughening features. In some embodiments, the base of the nodular feature may generally represent the maximum width. In some embodiments, a nodular feature may be characterized as having H in a range of 0.4 to 5.0 μm, a W/B ratio in a range of about 1 to 1.2, and/or H/B aspect ratio in a range of about 0.5 to 1.5. In some cases, a roughening feature may be defined as either nodular or a first-type nanopillar.

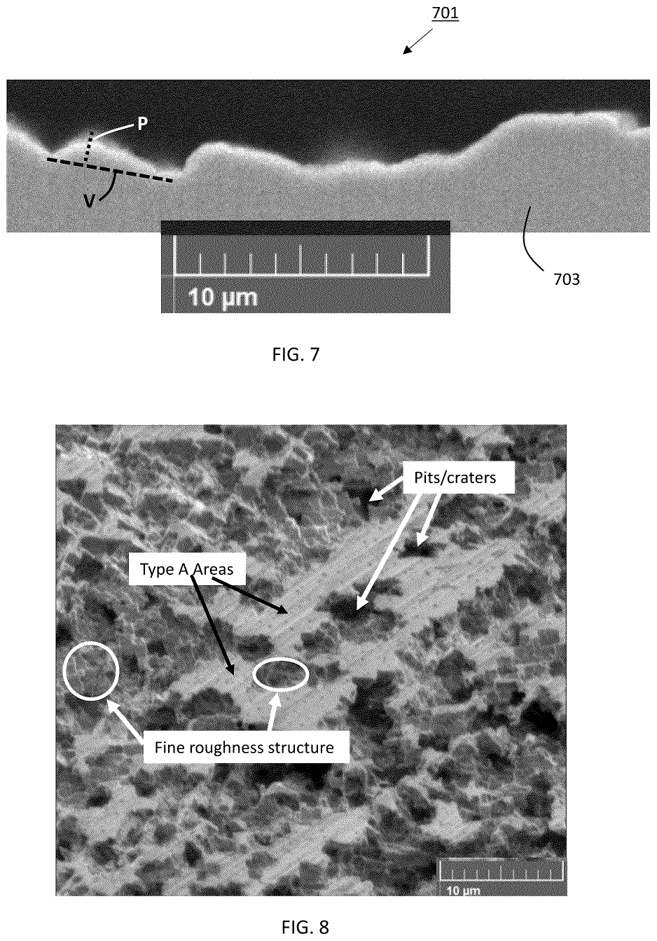

In some embodiments, the surface roughness may be relatively large with respect to Rₐ or R_{z}, but the features themselves may be broad roughness features, e.g., as bumps and hills separated on average by at least about 2 μm. FIG. 7 is an SEM cross-sectional view of a portion of a current collector having broad roughness features. Current collector 701 includes electrically conductive layer 703 (the surface layer is not easy to make out in the SEM). This current collector had a measured surface roughness Rₐ=508 nm. The broad roughness features may be characterized by a peak height P and a valley-to-valley separation V. The ratio P/V represents an aspect ratio of the broad roughness feature. In some embodiments, on average, V is greater than at least 3 μm or alternatively at least 4 μm, and P/V is less than 0.8, alternatively less than 0.6. In some embodiments, on average, V is in a range of 3-4 μm, alternatively 4-5 μm, alternatively 5-6 μm, alternatively 6-8 μm, alternatively, 8-10 μm, alternatively 10-12 μm, alternatively 12-15 μm, and P/V is in a range of 0.2-0.3, alternatively 0.3-0.4, alternatively 0.4-0.5, alternatively 0.5-0.6, alternatively 0.6-0.7, alternatively 0.7-0.8, or any combination of ranges thereof for V and P/V. In some embodiments, V is the same as the peak-to-peak separation.

In some embodiments, a roughened current collector surfaces may appear pitted, cratered, or corroded. A non-limiting example is shown in FIG. 8, in this case made by a chemical roughening, oxidative treatment. Some areas corresponding approximately to the original surface can still be seen such as in Type A areas—one can still make out lines from the original roll-formed surface. The majority of the surface has been etched leading to very rough, random, cratered topology that is much rougher than the original surface. In some embodiments, at least 50% of the surface of the electrically conductive layer has been etched to a depth of at least 0.5 μm from the original surface, alternatively at least 1.0 μm, where the surface roughness Rₐ is at least 400 nm, alternatively at least 500 nm, alternatively at least 600 nm, alternatively at least 700 nm. Numerous pits/craters are visible. In some embodiments when inspected by SEM analysis, an average 100 square micron area of a chemically roughened current collector may include at least 1 recognizable pit, alternatively at least 2, 3, or 4. In some embodiments, a “pit” may be a feature characterized by a width and a depth, where the depth to width ratio is at least 0.25, alternatively at least 0.5. The pit may be a concavity defined by the current collector. The top of the pit may be the top surface of the current collector. In some embodiments, a pit may be at least 2 μm wide. In some embodiments, pits may occupy 2% to 5% of the surface area of the current collector, alternatively 5% to 10%, alternatively, 10% to 20%, alternatively 20% to 30%, alternatively 30% to 40%, alternatively 40% to 50%. In some embodiments, some etched areas or pitted areas may have a fine roughness structure formed from the coalescence of secondary smaller pits or craters. Such secondary pits may have an average width or diameter of less than about 2 μm, alternatively less than about 1 μm. In some embodiments, secondary pits may occupy 5% to 10% of the surface area of the current collector, alternatively 5% to 10%, alternatively, 10% to 20%, alternatively 20% to 30%, alternatively 30% to 40%, alternatively 40% to 50%, alternatively 50% to 60%, alternatively, 60% to 70%, alternatively 70% to 90%.

In some embodiments, roughening of the electrically conductive layer may include, for example, physical abrasion (such as sandpaper, sand blasting, polishing, or the like), ablation (such as by laser ablation), embossing, stamping, casting, imprinting, chemical treatments, electrochemical treatments, or thermal treatments. In some cases, such roughening may be used to form one or more of the roughening features described above, e.g., nodular features, nanopillar features, broad roughness features, pitted features or the like. In some cases, roughening features may be random, or alternatively, may be patterned.

### Surface Layer

The surface layer may include a silicate compound. A silicate compound may include, or be formed from a solution containing, silicic acid or an anionic silicate species. Herein, an anionic silicate species is one that includes silicon and oxygen and is typically associated with an appropriate cationic moiety. In some cases, an anionic silicate species may be represented by equation (1)

$${( {[ {SiO}_{( 4 - x )} ]}^{( 4 - 2 x ) -} )}_{n} \qquad ( 1 )$$

where 0≤x<2, and n≥1. In some case, the anionic silicate species may include [SiO₄]⁴⁻ (x=0, n=1, which may in some cases be referred to as an orthosilicate), [SiO₃]²⁻ (x=1, n=1, which may in some cases be referred to as a metasilicate), or [Si₂O₇]⁶⁻ (x=0.5, n=2, which may in some cases be referred to as a pyrosilicate). Anionic silicate species may in some cases include larger structures, such as polysilicates where n≤3.

In some embodiments, the associated cationic moiety may include a proton, a metal (“a metal silicate”), an alkylammonium moiety, or a mixture thereof. A metal silicate may include an alkali metal, an alkaline earth metal, a transition metal, a post-transition metal. In some embodiments a silicate compound may include a mixture of silicic acid and a metal silicate.

In some embodiments a surface layer may be formed by contacting a current collector precursor with a silicate treatment agent. The current collector precursor generally includes the electrically conductive layer and may optionally include one or more additional surface sublayers as discussed elsewhere herein. The silicate treatment agent may include, for example, an aqueous mixture (solution, dispersion, emulsion, or the like) that includes a silicate compound. In some cases, the silicate compound may have a water solubility of at least 10 ppm, alternatively at least 50 ppm, or alternatively at least 100 ppm. In some cases, the treatment agent may include silicic acid, a sodium silicate, a potassium silicate, or a mixture thereof. In some embodiments, the aqueous mixture may have a pH of at least 2, alternatively at least 4. In some embodiments, the aqueous mixture may have a pH in a range of about 4 to 5, alternatively 5 to 6, alternatively 6 to 7, alternatively 7 to 8, alternatively 8 to 9, alternatively 9 to 10, alternatively 10 to 11, alternatively 11 to 12, or any combination of ranges thereof.

In some cases, the silicate treatment agent may be provided as a bath into which the current collector precursor is immersed, or alternatively it may be spray applied or otherwise coated onto the current collector precursor. Contact with the silicate treatment agent may optionally include agitation such as bath circulation, sparging, stirring, movement of the current collector precursor, or the like. The silicate treatment agent may be at ambient temperature, or may be controlled, for example, in a temperature range of about 0° C.-5° C., alternatively 5° C.-10° C., alternatively 10° C.-15° C., alternatively 15° C.-20° C., alternatively 20° C.-25° C., alternatively 25° C.-30° C., alternatively 30° C.-40° C., 40° C.-50° C., alternatively 50° C.-60° C., alternatively 60° C.-80° C., or any combination of ranges thereof. In some cases, contact with the silicate treatment agent may be followed by a rinse with a rinsing agent. In some embodiments, the rinsing agent may include water, such as distilled water, deionized water, or tap water. A rinsing agent may optionally include other materials such as surfactants, dispersants, neutralizing materials, or some other material.

In some embodiments, the areal density of silicon from the silicate compound in the surface layer may be at least 0.2 mg/m², alternatively at least 0.5 mg/m². In some embodiments, the areal density of silicon from the silicate compound in the surface layer may be in a range of 0.2-0.5 mg/m², alternatively 0.5-1.0 mg/m², alternatively 1.5-2 mg/m², alternatively 2-3 mg/m², alternatively 3-5 mg/m², alternatively 5-7 mg/m², alternatively 7-10 mg/m², alternatively 10-15 mg/m², alternatively 15-20 mg/m², alternatively 20-30 mg/m², alternatively 30-50 mg/m², or any combination of ranges thereof.

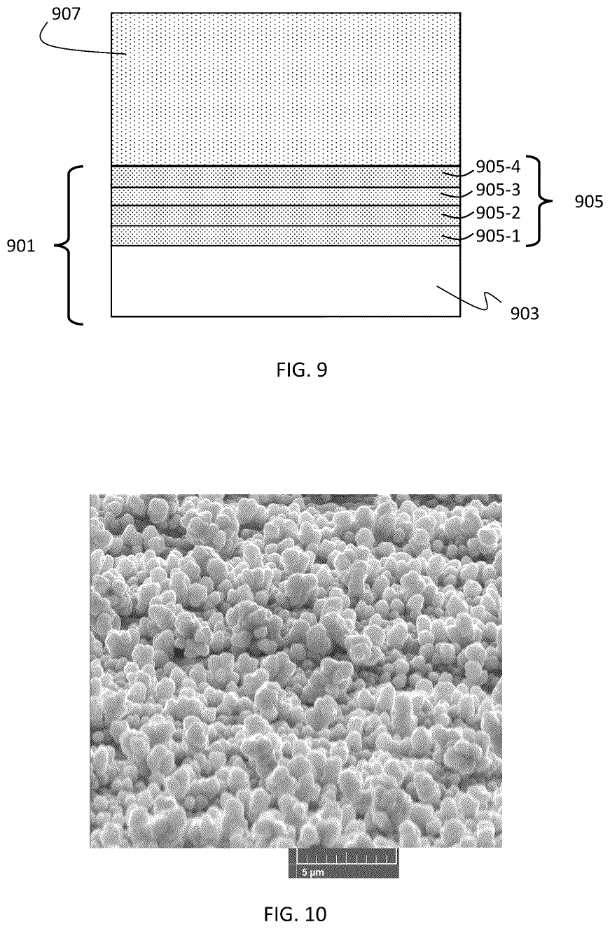

In some embodiments, the surface layer may be a single layer provided directly on the electrically conductive layer so that the silicate compound may be in direct contact with the electrically conductive layer. In some cases, the surface layer may include materials in addition to the silicate compound. In some embodiments, the surface layer may include two or more sublayers. Each sublayer of the two or more sublayers may have a composition different from the adjacent sublayer(s). The composition in each sublayer may be homogenous or heterogeneous. In some embodiments, at least one sublayer includes the silicate compound. A non-limiting example is shown in FIG. 9 illustrating surface layer 905 having up to four surface sublayers. Surface sublayer 905-1 overlays the electrically conductive layer 903. Surface sublayer 905-2 overlays surface sublayer 905-1, surface sublayer 905-3 overlays surface sublayer 905-2, and surface sublayer 905-4 overlays surface sublayer 905-3. A lithium storage layer 907 is provided over the uppermost surface sublayer, i.e., the sublayer furthest from the electrically conductive layer 903, which in FIG. 9 may be sublayer 905-4 if all four sublayers are present.

In some embodiments, the surface layer or a sublayer may include a silicate compound (“surface material A” in Table 1), which has been described above. In some embodiments, the surface layer or a sublayer may include a metal-oxygen compound. In some cases, a metal-oxygen compound may include a metal oxide or metal hydroxide (either or even a mixture may be considered “surface material B” in Table 1). In some cases, a metal-oxygen compound may include an oxometallate (“surface material C” in Table 1) In some embodiments, the surface layer or a sublayer may include a silicon compound (“surface material D” in Table 1) including or derived from a siloxane, a silane (i.e., a silane-containing compound), a silazane, or a reaction product thereof. Herein, a “silicon compound” does not include simple elemental silicon such as amorphous silicon, nor does it include a silicate compound. These materials are described in more detail below. Using FIG. 9 to help illustrate, Table 1 provides some non-limiting examples of surface layers wherein the surface materials are listed as A, B, C, and/or D, and in which sublayer. In some cases, “A & B” refers to a mixture of the two in a single surface sublayer. In any of these non-limiting embodiments, the surface layer may include a metal sublayer interposed between surface sublayer 905-1 and the electrically conductive layer. The metal sublayer may include a zero-valent metal and in some cases may be considered part of the electrically conductive layer, but in a relatively lower amount. For example, the metal sublayer may make up less than 10% of the total mass of the electrically conductive layer. In some embodiments, a metal sublayer may be provided adjacent to a surface sublayer 905-1 containing a metal-oxygen compound. In some embodiments, the metal sublayer may include zinc, nickel, tin, or manganese, or a combination thereof.

TABLE 1

| | Surface Material | | | |
|---|---|---|---|---|
| | Surface | Surface | Surface | Surface |
| Surface layer | Sublayer | Sublayer | Sublayer | Sublayer |
| example no. | 905-1 | 905-2 | 905-3 | 905-4 |
| 1 | A | | | |
| 2 | A | B | | |
| 3 | A | D | | |
| 4 | A&B | | | |
| 5 | A&B | D | | |
| 6 | A&D | | | |
| 7 | B | A | | |
| 8 | B | A | D | |
| 9 | B | A&D | | |
| 10 | C | A | | |
| 11 | C | A | D | |
| 12 | C | A&D | | |
| 13 | C | A&B | | |
| 14 | C | A&B | D | |
| 15 | C | B | A | |
| 16 | C | B | A | D |
| 17 | C | B | A&B | |
| 18 | C | B | A&B | D |
| 19 | C | B | A&D | |

### Metal-Oxygen Compounds

In some embodiments, the surface layer or a surface sublayer includes a metal-oxygen compound. The metal-oxygen compound may include an alkali metal, an alkaline earth metal, a transition metal, or a post transition metal. Unless otherwise noted, the term “transition metal” as used anywhere in the present application includes any element in groups 3 through 12 of the periodic table, including lanthanides and actinides. Metal-oxygen compounds may include metal oxides, metal hydroxides, oxometallates, or a mixture thereof. In some cases, the metal-oxygen compound may include a transition metal oxide, a transition metal hydroxide, a transition metal oxometallate, or a mixture thereof.

### Metal Oxides

In some embodiments, a surface layer or surface sublayer may include a metal oxide. In some embodiments, the metal oxide may include a transition metal oxide. In some embodiments, the metal oxide may include an oxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, a metal oxide may be an electrically conductive doped oxide, including but not limited to, indium-doped tin oxide (ITO) or an aluminum-doped zinc oxide (AZO). In some embodiments, the metal oxide may include an alkali metal oxide or alkaline earth metal oxide. In some embodiments the metal oxide may include an oxide of lithium. The metal oxide may include mixtures of metal oxides. For example, an “oxide of nickel” may optionally include other metal oxides in addition to nickel oxide. In some embodiments, a metal oxide includes an oxide of an alkali metal (e.g., lithium or sodium) or an alkaline earth metal (e.g., magnesium or calcium) along with an oxide of a transition metal (e.g., titanium, nickel, or copper). In some embodiments, the metal oxide may include some amount of hydroxide such that the ratio of oxygen atoms in the form of hydroxide relative to oxide is equal to or less than 1-to-1, respectively, alternatively less than 1-to-2, 1-to-3, or 1-to-4. The metal oxide may include a stoichiometric oxide, a non-stoichiometric oxide or both. In some embodiments, the metal within the metal oxide may exist in multiple oxidation states. Ordinarily, oxometallates may be considered a subclass of metal oxides. For the sake of clarity, any reference herein to “metal oxide” with respect to its use in a surface layer or sublayer excludes oxometallates unless otherwise stated.

In some embodiments, a surface sublayer of metal oxide (“metal oxide sublayer”) may be at least 1 monolayer in thickness, alternatively at least 2, 3, 5, or 10 monolayers. In some embodiments, a surface layer or sublayer having a metal oxide material may have an average thickness of at least 0.1 nm, alternatively at least 0.2 nm. In some embodiments, a surface layer or sublayer having a metal oxide material may have an average thickness of less than 5000 nm, alternatively less than 3000 nm. In some embodiments, a surface layer or sublayer having a metal oxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal oxide may be formed by atomic layer deposition (ALD), chemical vapor deposition (CVD), thermal vapor deposition, or sputtering. In some cases, a metal oxide may be formed by coating a suspension of metal oxide particles. In some embodiments, a metal oxide may be electrolytically plated or electrolessly plated (which may include “immersion plating”). In some embodiments, a metal oxide may be co-deposited with a silicate compound by any of the above-mentioned methods.

In some embodiments, a metal oxide precursor composition may be coated or printed over a current collector optionally having one or more surface sublayers as described above and then treated to form the metal oxide. Some non-limiting examples of metal oxide precursor compositions include sol-gels (metal alkoxides), metal carbonates, metal acetates (including organic acetates), metal hydroxides and metal oxide dispersions. The metal oxide precursor composition may be thermally treated to form the metal oxide.

In some embodiments, the metal oxide precursor composition may include a metal, e.g., metal-containing particles or a sputtered metal layer. The metal may then be oxidized in the presence of oxygen (e.g., thermally), electrolytically oxidized, chemically oxidized in an oxidizing liquid or gaseous medium or the like to form the metal oxide.

In some embodiments a silicate compound may be co-deposited with any of the above-mentioned metal oxide precursor compositions.

### Metal Hydroxides

In some embodiments, a surface layer or surface sublayer may include a metal hydroxide. In some embodiments, the metal hydroxide may include a transition metal hydroxide. In some embodiments, the metal hydroxide may include a hydroxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, the metal hydroxide may include an alkali metal hydroxide or alkaline earth metal hydroxide. In some embodiments, the metal hydroxide may include a hydroxide of lithium. The metal hydroxide may include mixtures of metal hydroxides. For example, a “hydroxide of nickel” may optionally include other metal hydroxides in addition to nickel hydroxide. In some embodiments, a metal hydroxide includes a hydroxide of an alkali metal (e.g., lithium or sodium) or an alkaline earth metal (e.g., magnesium or calcium) along with a hydroxide of a transition metal (e.g., titanium, nickel, or copper). In some embodiments, a metal hydroxide sublayer may include some amount of oxide such that the ratio of oxygen atoms in the form of oxide relative to hydroxide is less than 1-to-1, respectively, alternatively less than 1-to-2, 1-to-3, or 1-to-4. The metal hydroxide may include a stoichiometric hydroxide, a non-stoichiometric hydroxide, or both. In some embodiments, the metal hydroxide may include multiple oxidation states of the same metal atom.

In some embodiments, a surface sublayer of metal hydroxide (“metal hydroxide sublayer”) may be at least 1 monolayer in thickness, alternatively at least 2, 3, 5, or 10 monolayers. In some embodiments, a surface layer or sublayer having a metal hydroxide material may have an average thickness of at least 0.1 nm, alternatively at least 0.2 nm. In some embodiments, a surface layer or sublayer having a metal hydroxide material may have an average thickness of less than 5000 nm, alternatively less than 3000 nm. In some embodiments, a surface layer or sublayer having a metal hydroxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal hydroxide may be formed by atomic layer deposition (ALD), chemical vapor deposition (CVD), thermal vapor deposition, or sputtering. In some cases, a metal hydroxide may be formed by coating a suspension of metal hydroxide particles. In some embodiments, a metal hydroxide may be electrolytically plated or electrolessly plated (which may include “immersion plating”). In some embodiments, a metal hydroxide may be co-deposited with a silicate compound by any of the above-mentioned methods.

In some embodiments, a metal hydroxide precursor composition may be coated or printed over a current collector optionally having one or more surface sublayers as described above and then treated to form the metal hydroxide. Some non-limiting examples of metal hydroxide precursor compositions may include sol-gels (metal alkoxides), metal carbonates, metal acetates (including organic acetates) and metal oxide dispersions. The metal hydroxide precursor composition may be thermally treated, optionally in the presence of water or an alkaline aqueous medium to form the metal hydroxide.

In some embodiments, the metal hydroxide precursor composition may include a metal, e.g., metal-containing particles or a metal layer. The metal may then be oxidized in the presence of oxygen (e.g., thermally), electrolytically oxidized, chemically oxidized in an oxidizing liquid or gaseous medium or the like to form the metal hydroxide. Such oxidation may optionally be carried out in the presence of water and/or under alkaline conditions.

In some embodiments a silicate compound may be co-deposited with any of the above-mentioned metal hydroxide precursor compositions.

### Oxometallates

As noted previously, oxometallates herein are considered separately from other non-anionic metal oxides. Oxometallates may be considered a type of metal oxide where the metal oxide moiety is anionic in nature and is associated with a cation, which may optionally be an alkali metal, an alkaline earth metal, a transition metal, or even a post transition metal. In some embodiments, a transition oxometallate may include scandium, titanium, vanadium, manganese, iron, cobalt, nickel, copper, yttrium, zirconium, niobium, molybdenum, tantalum, or tungsten. In some embodiments, a transition oxometallate may include a chromate, tungstate, vanadate, or molybdate. In some embodiments, the surface layer or surface sublayer may include, or be formed from, a transition oxometallate other than chromate.

In some embodiments, an oxometallate may be formed by sputtering. In some cases, an oxometallate may be formed by coating a suspension or solution of oxometallate material or particles. In some embodiments, an oxometallate may be electrolytically plated or electrolessly plated (which may include “immersion plating”). In some embodiments, such electrolytic or electroless plating may use a solution including a transition oxometallate. In some cases, the nature of the deposited coating may include a mixture of transition metal oxide, hydroxide and/or oxometallate. In some embodiments, an oxometallate may be co-deposited with a silicate compound by any of the above-mentioned methods.

A non-limiting, representative electrolytic chromate solution may have a chromic acid or potassium chromate concentration of 2 g/l to 7 g/l, and pH of 10 to 12. The solution may optionally be warmed to a temperature of 30° C. to 40° C. and a cathodic current density of 0.02 to 8 A/cm² applied to the electrically conductive layer, typically for a few seconds, to deposit the chromium-containing metal-oxygen compound. In some embodiments, such a surface layer or surface sublayer may be referred to as a chromate-treatment layer. The deposited chromium-containing metal-oxygen compound may include one or more of chromium oxide, chromium hydroxide, or chromate. At least some of the chromium may be present as chromium (III).

In some embodiments, the amount of a transition metal from a transition oxometallate in the surface layer or sublayer may be at least 0.5 mg/m², alternatively at least 1 mg/m², alternatively at least 2 mg/m². In some embodiments, the amount of the transition metal from a transition oxometallate is less than 250 mg/m². In some embodiments, the amount of the transition metal from a transition oxometallate may be in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-75 mg/m², alternatively 75-100 mg/m², alternatively 100-250 mg/m², or any combination of ranges thereof. In some embodiments, a surface layer or sublayer having an oxometallate material may be at least 0.2 nm thick, alternatively at least 0.5 nm thick, alternatively at least 1 nm thick, at least 2 nm thick. In some embodiments a surface layer or sublayer having an oxometallate material may have a thickness in a range of 0.2-0.5 nm, alternatively 0.5-1.0 nm, alternatively 1.0-2.0 nm, alternatively 2.0-5.0 nm, alternatively 5.0-10 nm, alternatively 10-20 nm, alternatively 20-50 nm, alternatively 50-100 nm, or any combination of ranges thereof.

A transition metallate generally refers to a transition metal compound bearing a negative charge. The anionic transition metal compound may be associated with one or more cations (a “transition metallate compound”), which may optionally be an alkali metal, an alkaline earth metal, ammonium, alkylammonium, another transition metal (which may be the same or different than the transition metal of the anionic transition metal compound), or some other cationic species. A transition oxometallate is a particular type of transition metallate. Besides transition oxometallates, some non-limiting examples of useful transition metallates may include sulfometallates, cyanometallates, and halometallates, which may be used singly or in combination, or in combination with oxometallates. Unless noted to the contrary, embodiments using a transition oxometallate may instead use a transition metallate.

### Silicon Compounds

In some embodiments, a surface layer or sublayer includes a silicon compound formed by treatment with a silane, a siloxane, or a silazane compound, any of which may be referred to herein as a silicon compound agent. As mentioned, a silicon compound or a silicon compound agent does not include silicate compounds. In some embodiments, the silicon compound agent treatment may increase adhesion to an overlying sublayer or to the lithium storage layer. In some embodiments, the silicon compound may be a polymer including, but not limited to, a polysiloxane. In some embodiments, a siloxane compound may have a general structure as shown in formula (2)

$$Si {( R )}_{n} {( {OR}^{′} )}_{4 - n} \qquad ( 2 )$$

wherein, n=1, 2, or 3, and R and R′ are independently selected substituted or unsubstituted alkyl, alkenyl, or aryl groups.

The silicon compound of the layer or sublayer may be derived from a silicon compound agent but have a different chemical structure than the agent used to form it. In some embodiments, the silicon compound may react with the underlying surface to form a bond such as a metal-oxygen-silicon bond, and in doing so, the silicon compound may lose one or more functional groups (e.g., an OR′ group from a siloxane). In some embodiments, the silicon compound agent may include groups that polymerize to form a polymer. In some embodiments, the silicon compound agent may form a matrix of Si—O—Si cross links. In some embodiments, the PECVD deposition of a lithium storage material may alter the chemical structure of the silicon compound agent or even form a secondary derivative chemical species. The silicon compound includes silicon. The silicon compound may be the result of a silicon compound agent reacting with 1, 2, 3, or 4 reactants in 1, 2, 3, or 4 different reactions.

A silicon compound agent may be provided in a solution, e.g., at about 0.3 g/l to 15 g/l in water or an organic solvent. Adsorption methods of a silicon compound agent include an immersion method, a showering method and a spraying method and are not especially limited. In some embodiments a silicon compound agent may be provided as a vapor and adsorbed onto an underlying sublayer. In some embodiments, a silicon compound agent may be deposited by initiated chemical vapor deposition (iCVD). In some embodiments, a silicon compound agent may include an olefin-functional silane moiety, an epoxy-functional silane moiety, an acryl-functional silane moiety, an amino-functional silane moiety, or a mercapto-functional silane moiety, optionally in combination with siloxane or silazane groups. In some embodiments, the silicon compound agent may be a siloxysilane. In some embodiments, a silicon compound agent may undergo polymerization during deposition or after deposition. Some non-limiting examples of silicon compound agents include hexamethyldisilazane (HMD), vinyltrimethoxysilane, vinylphenyltrimethoxysilane, 3-methacryloxypropyltrimethoxysilane, 3-glycidoxypropyltrimethoxysilane, 3-glycidoxypropyltriethoxysilane, 4-glycidylbutyltrimethoxysilane, 3-aminopropyltriethoxysilane, N-2-(aminoethyl)-3-aminopropyltrimethoxysilane, N-3-(4-(3-aminopropoxy)butoxy)propyl-3-aminopropyltrimethoxysilane, imidazolesilane, triazinesilane, 3-mercaptopropyltrimethoxysilane, 1,3,5,7-tetravinyl-1,3,5,7-tetramethylcyclotetrasiloxane, 1,3,5-trivinyl-1,3,5-trimethylcyclotrisiloxane, pentavinylpentamethylcyclopentasiloxane, and octavinyl-T8-silsequioxane. In some embodiments, a layer or sublayer including a silicon compound may include silicon, oxygen, and carbon, and may further include nitrogen or sulfur. In some embodiments, a silicon compound or silicon compound agent may be co-deposited with a silicate compound.

In some embodiments, treatment with a silicon compound agent may be followed by a step to drive off solvent or to initiate polymerization or another chemical transformation, wherein the step may involve heating, contact with a reactive reagent, or both. In some embodiments, a surface layer or sublayer formed using a silicon compound agent may have a silicon content in a range of 0.1 to 0.2 mg/m², alternatively in a range of 0.1-0.25 mg/m², alternatively in a range of 0.25-0.5 mg/m², alternatively in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-100 mg/m², alternatively 100-200 mg/m², alternatively 200-300 mg/m², or any combination of ranges thereof. In some embodiments, a surface layer or sublayer formed from a silicon compound agent may include up to one monolayer of the silicon compound agent or its reaction product, alternatively up to 2 monolayers; alternatively up to 4 monolayers, alternatively up to 6 monolayers, alternatively up to 8 monolayers, alternatively up to 10 monolayers, alternatively up to 15 monolayers, alternatively up to 20 monolayers, alternatively up to 50 monolayers, alternatively up to 100 monolayers, alternatively up to 200 monolayers. The surface layer or surface sublayer having the silicon compound may be porous. In some embodiments, the silicon compound may break down or partially breaks down during deposition of the lithium storage layer.

### Lithium Storage Layer

In some embodiments, the lithium storage layer may be a continuous porous lithium storage layer that includes a porous material capable of reversibly incorporating lithium. In some embodiments, the lithium storage layer includes silicon, germanium, antimony, tin, or a mixture of two or more of these elements. In some embodiments, the lithium storage layer is substantially amorphous. In some embodiments, a lithium storage layer includes substantially amorphous silicon. Such substantially amorphous storage layers may include a small amount (e.g., less than 20 atomic %) of crystalline material dispersed therein. The lithium storage layer may include dopants such as hydrogen, boron, phosphorous, sulfur, fluorine, aluminum, gallium, indium, arsenic, antimony, bismuth, nitrogen, or metallic elements. In some embodiments the lithium storage layer may include porous substantially amorphous hydrogenated silicon (a-Si:H), having, e.g., a hydrogen content of from 0.1 to 20 atomic %, or alternatively higher. In some embodiments, the lithium storage layer may include methylated amorphous silicon. Note that, unless referring specifically to hydrogen content, any atomic % metric used herein for a lithium storage material or layer refers to atoms other than hydrogen.

In some embodiments, the lithium storage layer, e.g., a continuous porous lithium storage layer, may include at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %. In some embodiments, a lithium storage layer, e.g., a continuous porous lithium storage layer, may include at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %. Note that in the case of prelithiated anodes as discussed below, the lithium content is excluded from this atomic % characterization.

In some embodiments, the lithium storage layer, e.g., a continuous porous lithium storage layer, includes less than 10 atomic % carbon, alternatively less than 5 atomic %, alternatively less than 2 atomic %, alternatively less than 1 atomic %, alternatively less than 0.5 atomic %. In some embodiments, a lithium storage layer, e.g., a continuous porous lithium storage layer, is substantially free (i.e., the lithium storage layer includes less than 1% by weight, alternatively less than 0.5% by weight) of carbon-based binders, graphitic carbon, graphene, graphene oxide, reduced graphene oxide, carbon black and conductive carbon. A few non-limiting examples of carbon-based binders may include organic polymers such as those based on styrene butadiene rubber, polyvinylidene fluoride, polytetrafluoroethylene, polyacrylic acid, carboxymethyl cellulose, or polyacrylonitrile.

The lithium storage layer, e.g., a continuous porous lithium storage layer, may include voids or interstices (pores), which may be random or non-uniform with respect to size, shape, and distribution. Such porosity does not result in, or result from, the formation of any recognizable lithium storage nanostructures such as nanowires, nanopillars, nanotubes, ordered nanochannels or the like. In some embodiments, the pores may be polydisperse. In some embodiments, the lithium storage layer, e.g., a continuous porous lithium storage layer, may be characterized as nanoporous. In some embodiments the lithium storage layer, e.g., a continuous porous lithium storage layer, has an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, alternatively 2.25-2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon. Note that a density of less than 2.3 g/cm³ is evidence of the porous nature of a-Si containing lithium storage layers.

In some embodiments, the majority of active material (e.g., silicon, germanium or alloys thereof) of the lithium storage layer, e.g., a continuous porous lithium storage layer, has substantial lateral connectivity across portions of the current collector, such connectivity extending around random pores and interstices. Referring again to FIG. 1, in some embodiments, “substantial lateral connectivity” means that active material at one point X in the lithium storage layer 107, e.g., a continuous porous lithium storage layer, may be connected to active material at a second point X′ in the layer at a straight-line lateral distance LD that is at least as great as the average thickness T of the lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the lithium storage layer may be described as a matrix of interconnected silicon, germanium or alloys thereof, with random pores and interstices embedded therein. In some embodiments, the lithium storage layer may have a sponge-like form. It should be noted that a continuous porous lithium storage layer does not necessarily extend across the entire anode without any lateral breaks and may include random discontinuities or cracks and still be considered continuous. In some embodiments, such discontinuities may occur more frequently on rough current collector surfaces. In some embodiments, the lithium storage layer, e.g., a continuous porous lithium storage layer, may include adjacent columns of silicon and/or nanoparticle aggregates. In some embodiments, the lithium storage layer may include a mixture of amorphous and crystalline silicon, e.g., nano-crystalline silicon having an average grain size of less than about 100 nm, alternatively less than about 50 nm, 20 nm, 10 nm, or 5 nm. In some cases, the lithium storage layer may include up to 30 atomic % nano-crystalline silicon relative to all silicon in the lithium storage layer.

In some embodiments, the lithium storage layer, e.g., a continuous porous lithium storage layer, includes a substoichiometric oxide of silicon (SiOₓ), germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof.

In some embodiments, the lithium storage layer, e.g., a continuous porous lithium storage layer, includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. Lithium storage layer having a substoichiometric nitride of silicon may also be referred to as nitrogen-doped silicon or a silicon-nitrogen alloy.

In some embodiments, the lithium storage layer, e.g., a continuous porous lithium storage layer, includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, the lithium storage layer, e.g., a continuous porous layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, hollow cathode, combinatorial PECVD and microwave sources may be used. In some embodiments, magnetron assisted RF PECVD may be used.

PECVD process conditions (temperatures, pressures, precursor gases, carrier gasses, dopant gases, flow rates, energies, and the like) can vary according to the particular process and tool used, as is well known in the art.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector. Example ranges for voltages and currents for the DC plasma source are 60 to 80 volts and 40 to 70 amperes, respectively.

Any appropriate silicon source may be used to deposit silicon. In some embodiments, the silicon source may be a silicon precursor gas including, but not limited to, silane (SiH₄), dichlorosilane (H₂SiCl₂), monochlorosilane (H₃SiCl), trichlorosilane (HSiCl₃), silicon tetrachloride (SiCl₄), diethylsilane, and mixtures thereof. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3-5, alternatively 5-10, alternatively 10-15, alternatively 15-20, or any combination of ranges thereof. In some embodiments, the gas flow ratio of hydrogen gas to silane is in a range of 0-0.1, alternatively 0.1-0.2, alternatively 0.2-0.5, alternatively 0.5-1, alternatively 1-2, alternatively 2-5, or any combination of ranges thereof. In some embodiments, higher porosity silicon may be formed and/or the rate of silicon deposition may be increased when the gas flow ratio of silane relative to the combined gas flows of silane and hydrogen increases. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001-0.0002, alternatively 0.0002-0.0005, alternatively 0.0005-0.001, alternatively 0.001-0.002, alternatively 0.002-0.005, alternatively 0.005-0.01, alternatively 0.01-0.02, alternatively 0.02-0.05, alternatively 0.05-0.10, or any combination of ranges thereof. Such gas flow ratios described above may refer to the relative gas flow, e.g., in standard cubic centimeters per minute (SCCM). In some embodiments, the PECVD deposition conditions and gases may be changed over the course of the deposition.

In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the lithium storage layer, e.g., a continuous porous lithium storage layer, depends on the storage material, desired charge capacity and other operational and lifetime considerations. Increasing the thickness typically provides more capacity. If the lithium storage layer becomes too thick, electrical resistance may increase and the stability may decrease. In some embodiments, the anode may be characterized as having an active silicon areal density of at least 1.0 mg/cm², alternatively at least 1.5 mg/cm², alternatively at least 3 mg/cm², alternatively at least 5 mg/cm². In some embodiments, the lithium storage layer may be characterized as having an active silicon areal density in a range of 1.5-2 mg/cm², alternatively in a range of 2-3 mg/cm², alternatively in a range of 3-5 mg/cm², alternatively in a range of 5-10 mg/cm², alternatively in a range of 10-15 mg/cm², alternatively in a range of 15-20 mg/cm², or any combination of ranges thereof. “Active silicon” refers to the silicon in electrical communication with the current collector that is available for reversible lithium storage at the beginning of cell cycling, e.g., after anode “electrochemical formation” discussed later. “Areal density” refers to the geometric surface area of the electrically conductive layer over which active silicon is provided. In some embodiments, not all of the silicon content is active silicon, i.e., some may be tied up in the form of non-active silicides or may be electrically isolated from the current collector.

In some embodiments the lithium storage, e.g., a continuous porous lithium storage layer, has an average thickness of at least 1 μm, alternatively at least 2.5 μm, alternatively at least 6.5 μm. In some embodiments, the lithium storage layer, e.g., a continuous porous lithium storage layer, has an average thickness in a range of about 0.5 μm to about 50 μm. In some embodiments, the lithium storage layer, e.g., a continuous porous lithium storage layer, comprises at least 80 atomic % amorphous silicon and/or has a thickness in a range of 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

### Other Anode Features

The anode may optionally include various additional layers and features. The current collector may include one or more features to ensure that a reliable electrical connection can be made in the energy storage device. In some embodiments, a supplemental layer is provided over the lithium storage structure. In some embodiments, the supplemental layer is a protection layer to enhance lifetime or physical durability. The supplemental layer may be an oxide formed from the lithium storage material itself, e.g., silicon dioxide in the case of silicon, or some other suitable material. A supplemental layer may be deposited, for example, by ALD, CVD, PECVD, evaporation, sputtering, solution coating, ink jet or any method that is compatible with the anode. In some embodiments, the top surface of the supplemental layer may correspond to a top surface of the anode.

A supplemental layer should be reasonably conductive to lithium ions and permit lithium ions to move into and out of the patterned lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}Oz, or LiₓSi_{y}Al₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. LIPON or other solid-state electrolyte materials having superior lithium transport properties may have a thickness of more than 100 nm, but may alternatively, be in a range of about 1 to about 50 nm.

In some embodiments, the lithium storage layer may be at least partially prelithiated prior to a first electrochemical cycle after battery assembly, or alternatively prior to battery assembly. That is, some lithium may be incorporated into the lithium storage layer to form a lithiated storage layer even prior to a first battery cycle. In some embodiments, the lithiated storage layer may break into smaller structures, including but not limited to platelets or islands, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of 1% to 5% of the theoretical lithium storage capacity of the lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the lithium storage layer. In some embodiments, the lithium storage layer, e.g., a continuous porous lithium storage layer, includes at least 80 atomic % amorphous silicon and at least 0.05 atomic % copper, alternatively at least 0.1 atomic % copper, alternatively at least 0.2 atomic % copper, alternatively at least 0.5 atomic % copper, alternatively at least 1 atomic % copper. In some embodiments, the lithium storage layer, e.g., a continuous porous lithium storage layer, may include at least 80 atomic % amorphous silicon and also include copper in an atomic % range of 0.05-0.1%, alternatively 0.1-0.2%, alternatively 0.2-0.5%, alternatively 0.5-1%, alternatively 1-2%, alternatively 2-3%, alternatively 3-5%, alternatively 5-7%, or any contiguous combination of ranges thereof. In some embodiments, the aforementioned ranges of atomic % copper may correspond to a cross-sectional area of the lithium storage layer of at least 1 μm², which may be measured, e.g., by energy dispersive x-ray spectroscopy (EDS). In some embodiments, there is a gradient where the concentration of copper in portions of the lithium storage layer near the current collector is higher than portions further from the current collector. In some embodiments, instead of copper or in addition to copper, the lithium storage layer may include a transition metal that is from a material forming part of the surface layer. The atomic % of such transition metals may be present in the lithium storage layer in any of the atomic % ranges mentioned above with respect to copper. In some embodiments, the lithium storage layer may include more copper than other transition metals. Special thermal treatments are not always necessary to achieve migration of transition metals into the lithium storage layer.

In some embodiments, thermally treating the anode may be done in a controlled environment having a low oxygen and water (e.g., less than 10 ppm or partial pressure of less than 0.1 Torr, alternatively less than 0.01 Torr) content to prevent degradation. In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, mesh or fabric.

### Battery Features

The preceding description relates primarily to the anode/negative electrode of a lithium-ion battery (LIB). The LIB typically includes a cathode/positive electrode, an electrolyte and a separator (if not using a solid-state electrolyte). As is well known, batteries can be formed into multilayer stacks of anodes and cathodes with an intervening separator. Alternatively, anode/cathode stacks can be formed into a so-called jelly-roll. Such structures are provided into an appropriate housing having desired electrical contacts.

### Cathode

Positive electrode (cathode) materials include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn_{z}O₂, LiNiₓCo_{y}Al_{z}O₂, LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials are typically provided on, or in electrical communication with, an electrically conductive cathode current collector.

### Current Separator

The current separator allows ions to flow between the anode and cathode but prevents direct electrical contact. Such separators are typically porous sheets. Non-aqueous lithium-ion separators are single layer or multilayer polymer sheets, typically made of polyolefins, especially for small batteries. Most commonly, these are based on polyethylene or polypropylene, but polyethylene terephthalate (PET) and polyvinylidene fluoride (PVdF) can also be used. For example, a separator can have >30% porosity, low ionic resistivity, a thickness of ~10 to 50 μm and high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability.

### Electrolyte

The electrolyte in lithium ion cells may be a liquid, a solid, or a gel. A typical liquid electrolyte includes one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles.

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiClO₄ LiAsF₆, LiN(CF₃SO₂)₂ (“LiTFSI”), LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl)imidazole), and combinations thereof.

In some embodiments, the total concentration of a lithium salt in a liquid non-aqueous solvent (or combination of solvents) is at least 0.3 M, alternatively at least 0.7M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

In some embodiments, the battery electrolyte includes a non-aqueous ionic liquid and a lithium salt. Additives may be included in the electrolyte to serve various functions such as to stabilize the battery. For example, additives such as polymerizable compounds having an unsaturated double bond may be added to stabilize or modify the SEI. Certain amines or borate compounds may act as cathode protection agents. Lewis acids can be added to stabilize fluorine-containing anions such as PF₆. Safety protection agents include those to protect overcharge, e.g., anisoles, or act as fire retardants, e.g., alkyl phosphates.

### Solid-State and Gel Electrolytes

A solid-state electrolyte (SSE) includes a source of mobile lithium ions that diffuse between the anode and the cathode (to the anode during charging and away from the anode during discharging). The three main families of SSE are solid polymer electrolytes (SPEs), solid inorganic electrolytes (SIEs), and hybrid SSE which uses both SPE and SIE materials. In some cases, the source of lithium ion may include a lithium salt, which may be in the form of a small molecule (e.g., LiTSFI, LiPF₆ or some any other lithium salt described elsewhere) suspended or dissolved in a SSE matrix. In some cases, a SPE material may include an anionic functional group that may act as the lithium salt counterion. The SSE may optionally include plasticizers, rheology control agents, or even a small amount of organic solvent(s).

A few non-limiting examples of polymeric materials that may be used in the SSE composition include poly(ethylene oxide) (PEO), poly(acrylonitrile) (PAN), poly(methyl methacrylate) (PMMA), poly(vinyl alcohol) (PVA), poly(trimethylene carbonate), diester-based polymer, PVdF-based polymers, polycaprolactone, and their derivatives or copolymers, which may be used alone or in combination. The polymer of the SSE may in some cases be cross-linked or branched. The polymer may be a block copolymer. A polymer SSE may be fully amorphous or include some crystallinity. The polymer may include anionic functional groups.

A few non-limiting classes of SIE material that may be used in the SSE composition include b-aluminas, NASICONs, perovskites, antiperovskites, garnets, complex hydrides, and solid sulfides.

In some embodiments, under battery operating conditions, the SSE may have a lithium-ion conductivity in a range of 0.0001 mS/cm to 0.001 mS/cm, alternatively in a range of 0.001 mS/cm to 0.01 mS/cm, alternatively in a range of 0.01 mS/cm to 0.1 mS/cm, alternatively in a range of 0.1 mS/cm to 1.0 mS/cm, alternatively higher than 1 mS/cm.

Gel electrolytes may in some cases be similar to solid polymer electrolytes described above, but that generally employ lower viscosity materials or mixtures, e.g., lower molecular weight polymers, plasticizers, or the like. There is no standard delineation of viscosities between what constitutes a solid-state electrolyte, a gel electrolyte, or a liquid electrolyte. Herein, gel electrolytes may be those having a viscosity in a range of about 1 Pa-sec to 1000 Pa-sec, whereas liquid electrolytes may be lower than this range and solid-state electrolytes (if even measurable) may be higher than this range. Some solid-state electrolytes, particularly SIEs and higher molecular weight solid polymers, are not readily characterized by a viscosity metric. Note that a polymer separator made from a free-standing film that may have gel-like properties in the presence of liquid electrolyte is not considered herein as a gel electrolyte, but as a separator.

In some cases, a solid-state electrolyte may be used without the separator(s) because it may serve as the separator itself so long as it is electrically insulating, ionically conductive, electrochemically stable, and mechanically stable. If the SSE is more gel-like, then the cell may still benefit from a separator. In some cases, multiple solid-state or gel electrolytes may be used, e.g., one electrolyte material associated with the anode (anolyte), another electrolyte material associated with the cathode (catholyte), and/or an electrolyte material disposed in between and associated with both the anode and cathode. In some embodiments, an electrolyte may be initially in a liquid state but may be in situ polymerized to a gel or solid state.

### Electrochemical Formation

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated pillars or islands, generally with a height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are non-symmetrical resulting in such islands or pillars.

In some embodiments, electrochemical cycling conditions may be set to utilize only a portion of the theoretical charge/discharge capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

### EXAMPLES

### PECVD

An Oxford Plasmalabs System 100 PECVD tool was used to deposit silicon onto various current collectors. Unless otherwise noted, depositions were conducted at about 300° C. at an RF power in a range of about 225 to 300 W. The deposition gas was a mixture of silane and argon in a gas flow ratio of about 1 to 12, respectively. Unless otherwise noted, the deposition time was 60 minutes which provided about a 10-12 μm thick, porous amorphous silicon layer on the current collector.

### Comparative Anode C-1

Current collector sample CC-1 was a 26 μm thick copper foil having surface roughness of Rₐ=0.164 μm and R_{z}=1.54 μm. CC-1 did not have a surface layer of the present disclosure. An attempt was made to deposit silicon onto one side of CC-1 using PECVD conditions noted above. Silicon deposition was stopped after 30 minutes in this comparative example. The silicon did not adhere sufficiently for electrochemical testing and no further characterization was made.

### Comparative Anode C-2

In this test, it is shown that electrodepositing copper roughening features alone is generally not sufficient to improve adhesion of silicon. Copper Foil A (high purity copper) was 25 μm thick, a tensile strength of about 275 MPa, and a starting surface roughness Rₐ of 167 nm. Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01M CuSO₄ (aq) with 1M H₂SO₄. Electrodepositions on metal foil were performed using a plating fixture such that just one side of the metal foil was exposed for the electrodeposition. The counter electrode was platinum/niobium mesh spaced 1.9 cm from the metal foil. Current was supplied to the foil at 100 mA/cm² for 100 sec (conditions suitable to deposit copper roughening features), the foil was removed and rinsed in DI water and air dried. The surface roughness Rₐ was 246 nm and surface roughness R_{z} was 2.3 μm. When silicon was deposited by PECVD as described above, it easily flaked off.

### Example Anodes

In some tests, current collectors were prepared from Copper Foil C which included copper roughening features, and initially, a chromate anticorrosion coating, was 18 μm thick, had a tensile strength of about 414 MPa, and a surface roughness Rₐ of 406 nm. An SEM of Copper Foil C is shown in FIG. 10 and the copper roughening features are evident which may be characterized as nodular or nanopillar features. Copper Foil C may have an SEM cross-section similar to that shown in FIG. 6B. To clean and remove the chromate anticorrosion coating, Copper Foil C was sonicated in acetone for 10 minutes, and then ethyl alcohol for 10 minutes. The sample was rinsed in DI water, immersed in 10% sulfuric acid for 30 seconds and rinsed with water to form Copper Foil C′. Copper Foil C′ was then used in subsequent treatments to form surface layers as described below. Although no SEM was taken of Copper Foil C′, it is expected to be similar to that of Copper Foil C.

Note that Copper Foil C′ itself (without further modification) may not be commercially viable as a current collector because of the non-uniform formation of copper oxide at the surface over time due to lack of any anticorrosion coatings. In some cases, at elevated temperatures and reduced pressures as are sometimes used in PECVD, the copper oxide may cause potential contamination of the PECVD equipment. In some embodiments, surface layers of the present disclosure may also act as anticorrosion coatings.

### Silicate Compound Treatment Mixture SCT-1

9.1 g of potassium silicate solution (20.8% SiO₂) was added to 500 mL of water. SCT-1 had a pH of 10.75.

### Silicate Compound Treatment Mixture SCT-2

1 g of silicic acid (H₂SiO₃) was added to 500 mL of water and heated to boiling in a microwave. The solution was allowed to cool to room temperature before use. SCT-2 had a pH of 7.0.

### Silicate Compound Treatment Mixture SCT-3

0.62 g of Boric Acid was added to 500 mL of SCT-2. SCT-3 had a pH of 5.2.

### Example Anode E-1

Copper Foil C′ was immersed into SCT-1 for 2 minutes at room temperature with no forced convection. The sample was then rinsed with DI water and allowed to dry in air. Silicon was deposited onto the surface layer-modified current collector using conditions described previously.

### Example Anode E-2

Copper Foil C′ was immersed into SCT-1 for 2 minutes at room temperature and turned every 15 seconds to provide some agitation. The sample was then rinsed with DI water and allowed to dry in air. Silicon was deposited onto the surface layer-modified current collector using conditions described previously.

### Example Anode E-3

Copper Foil C′ was first dipped into 1M NaOH and then immersed into SCT-1 for 2 minutes at room temperature and turned every 15 seconds. The sample was then rinsed with DI water and allowed to dry in air. Silicon was deposited onto the surface layer-modified current collector using conditions described previously.

### Example Anode E-4

Copper Foil C′ was immersed into SCT-2 for 10 minutes at room temperature with no forced convection. The sample was then rinsed with DI water and allowed to dry in air. Silicon was deposited onto the surface layer-modified current collector using conditions described previously.

### Example Anode E-5

Copper Foil C′ was immersed into SCT-3 for 2 minutes at room temperature with no forced convection. The sample was then rinsed with DI water and allowed to dry in air. Silicon was deposited onto the surface layer-modified current collector using conditions described previously.

### Example Anode E-6

Copper Foil C′ was immersed into SCT-3 for 2 minutes at room temperature and turned every 15 seconds to provide some agitation. The sample was then rinsed with DI water and allowed to dry in air. Silicon was deposited onto the surface layer-modified current collector using conditions described previously.

For all of the Example Anodes, it may be that some amount of a metal oxide- or metal hydroxide-containing sublayer (e.g., a copper oxide, a copper hydroxide, or a mixture thereof) is present interposed between the silicate compound and the metallic copper foil. Alternatively, or in addition, some copper oxide, copper hydroxide, or a mixture thereof mixed with the silicate compound. Such mixture may be heterogeneous or homogeneous, and the content of chemical components may optionally include a concentration gradient within the surface layer. In the case of Example Anode E-3 it may be that more copper oxide or copper hydroxide was formed than in other samples, due to the NaOH pretreatment.

### Electrochemical Testing—Half Cells

Half cells were constructed using a 0.80 cm diameter punch of each anode. Lithium metal served as the counter electrode which was separated from the test anode using Celgard™ separators. The standard electrolyte solution (“standard”) included: a) 88 wt. % of 1.2 M LiPF₆ in 3:7 EC:EMC (weight ratio); b) 10 wt. % FEC; and 2 wt. % VC. Anodes first underwent an electrochemical formation step. The electrochemical formation step is used to form an initial SEI layer. Relatively gentle conditions of low current and/or limited voltages may be used to ensure that the anode is not overly stressed. In the present examples, electrochemical formation included several cycles over a wide voltage range (about 0.01 to 1.2V) at C-rates ranging from C/20 to C/10. The total active silicon (mg/cm²) available for reversible lithiation and total charge capacity (mAh/cm²) was determined from the electrochemical formation step data. Formation losses were calculated by dividing the change in active areal charge capacity (initial first charge capacity minus last formation discharge capacity) by the initial areal first charge capacity. While silicon has a theoretical charge capacity of about 3600 mAh/g when used in lithium-ion batteries, it has been found that cycle life may improve if only a portion of the full capacity is used. For all anodes, the performance cycling was set to use a portion of the total capacity, typically in a range of about 1100-1600 mAh/g. The performance cycling protocol included 3.2C (for 15 min) or 1C charge rate (both considered aggressive in the industry) and C/3 discharge to roughly a 15% state of charge. In a couple examples, the cycling protocol included 1C charging and 1C discharging (also considered aggressive in the industry). A 10-minute rest was provided between charging and discharging cycles. Note that the test using 3.2C charging for 15 minutes is based on a test commonly used in the automotive industry. The 15-minute period corresponds to charging to a maximum 80% of the anode's rated capacity.

Table 2 summarizes the properties and cycling performance of the Example Anodes under various cycling protocols (Test Nos. 1-14). The “charge capacity” in Table 2 refers to the total areal charge density passed per charge or discharge operation. The rated capacities for 3.2C charging tests were actually 25% higher than values listed in the table. In some commercial uses, the anodes should have a charge capacity of at least 1.5 mAh/cm² and be able to charge at a rate of 1C with a cycle life of at least 100 cycles, meaning that the charge capacity should not fall lower than 80% of the initial charge capacity after 100 cycles. The number of cycles it takes for an anode to fall below 80% of the initial charge is commonly referred to as its “80% SoH cycle life” where “SoH” refers to “state-of-health”. All of the tests used anodes at a charge capacity of greater than 1.6 mAh/cm² and each one showed a cycle life of greater than 150 cycles at 1C charging. At 3.2C charge and C/3 discharge, all tests showed a cycle life of at least 200 cycles. Some tests demonstrated a cycle life greater than 300, 400, 500, or even 600 cycles. Note that Test Nos. 5 and 6 were still cycling at the time of this filing but had each surpassed 200 cycles. It is noted also that the formation losses for these tests were generally about 25% or less, which is generally acceptable. In general, a formation loss of less than about 15% is considered very good and may sometimes be indicative of a highly stable a-Si anode. It has been observed that high formation losses are sometimes indicative of an unstable anode, although there are exceptions. It is noted that the E-3 anodes (tests 6 and 7) have higher formation losses than the other samples. In this case, the higher formation loss may be due to some irreversible reactions involving the surface layer or sublayer which may have more copper oxide or copper hydroxide than other samples and may not necessarily signify low stability of the silicon.

In some embodiments, anodes of the present disclosure may provide a charge capacity of at least 2.5 mAh/cm² and an 80% SoH cycle life of at least 150 cycles at a charge rate of at least 1C and a discharge rate of at least C/3, or alternatively at a discharge rate of at least 1C. In some embodiments, anodes of the present disclosure may provide a charge capacity of at least 2.5 mAh/cm² and an 80% SoH cycle life of at least 200 cycles at a charge rate of at least 1C and a discharge rate of at least C/3. In some embodiments, anodes of the present disclosure may provide a charge capacity of at least 1.7 mAh/cm² and an 80% SoH cycle life of at least 300 cycles at a charge rate of at least 3.2C and a discharge rate of at least C/3.

TABLE 2

| Test | | Charge/Discharge | Capacity | Form. | Cycle |
|---|---|---|---|---|---|
| No. | Anode | rate | (mAh/cm²) | Losses (%) | life |
| 1 | E-1 | 1 C-C/3 | 2.59 | 9 | 360 |
| 2 | E-1 | 1 C-1 C | 2.59 | 9 | 189 |
| 3 | E-1 | 3.2 C-C/3 | 1.75 | 10 | 600 |
| 4 | E-2 | 1 C-C/3 | 2.59 | 7 | 226 |
| 5 | E-2 | 3.2 C-C/3 | 1.75 | 8 | 511 |
| 6 | E-3 | 1 C-C/3 | 2.19 | 24 | 548 |
| 7 | E-3 | 3.2 C-C/3 | 1.67 | 26 | 296 |
| 8 | E-4 | 1 C-C/3 | 2.59 | 10 | 345 |
| 9 | E-4 | 1 C-1 C | 2.59 | 7 | 174 |
| 10 | E-4 | 3.2 C-C/3 | 1.75 | 8 | 669 |
| 11 | E-5 | 1 C-C/3 | 2.59 | 14 | 228 |
| 12 | E-5 | 3.2 C-C/3 | 1.75 | 11 | 445 |
| 13 | E-6 | 1 C-C/3 | 2.59 | 11 | 184 |
| 14 | E-6 | 3.2 C-C/3 | 1.75 | 8 | 341 |

### Additional Observations

Some tests using silicate compound treatment mixtures at very low pH, e.g., pH of about 0 or less, resulted in the PECVD-deposited silicon not adhering strongly to the current collector. Thus, in some cases, the pH may be above 0, for example, at least 1 or at least 2.

Some tests used a copper foil (Copper Foil D) similar to that shown in FIG. 7 which had broad roughness features, but did not have roughening features such as nodules or nanopillars as in Copper Foil C. In some cases, when this Copper Foil D was contacted with a silicate compound treatment mixture in a manner similar to E-2, E-3, or E4, the PECVD-deposited silicon did not adhere strongly. Thus, in some cases, the current collector may include roughening features such as nodules or nanopillars.

Although the present anodes have been discussed with reference to batteries, in some embodiments the present anodes may be used in hybrid lithium-ion capacitor devices.

Still further embodiments herein include the following enumerated embodiments.
1. An anode for an energy storage device, the anode including:
a current collector including an electrically conductive layer and a surface layer including a silicate compound disposed over the electrically conductive layer; and
a lithium storage layer overlaying and in contact with the surface layer,
wherein the lithium storage layer includes at least 40 atomic % silicon, germanium, or a combination thereof.
2. The anode of embodiment 1, wherein the lithium storage layer is substantially free of carbon-based binders.
3. The anode of embodiment 1 or 2, wherein the electrically conductive layer includes roughening features.
4. The anode of embodiment 3, wherein the roughening features include nanopillar features.
5. The anode of embodiment 4, wherein the nanopillar features are characterized by a height H in a range of 0.4 μm to 5.0 μm, a maximum width W in a range of 0.4 μm to 3.0 μm, and an aspect ratio H/W in a range of 0.8 to 10.
6. The anode of embodiment 4 or 5 wherein an average 10 μm by 10 μm surface of the electrically conductive layer includes at least 3 nanopillar features.
7. The anode according to any of embodiments 3-6, wherein the roughening features include electrodeposited copper roughening features.
8. The anode according to any of embodiments 1-7, wherein the silicate compound is in contact with the electrically conductive layer.
9. The anode according to any of embodiments 1-8, wherein the silicate compound includes silicic acid.
10. The anode according to any of embodiments 1-9, wherein the silicate compound includes a metal silicate.
11. The anode of embodiment 10, wherein the metal silicate includes an alkali metal or an alkaline earth metal.
12. The anode of embodiment 10 or 11, wherein the metal silicate includes a post transition metal.
13. The anode according to any of embodiments 10-12, wherein the metal silicate includes a transition metal.
14. The anode according to any of embodiments 1-13, wherein an areal density of silicon from the silicate compound in the surface layer is in a range of 0.5-30 mg/m².
15. The anode according to any of embodiments 1-14, wherein the surface layer further includes a metal-oxygen compound.
16. The anode of embodiment 15, wherein the metal-oxygen compound includes a transition metal.
17. The anode of embodiment 15 or 16, wherein the metal-oxygen compound includes a metal oxide.
18. The anode according to any of embodiments 15-17, wherein the metal-oxygen compound includes a metal hydroxide.
19. The anode according to any of embodiments 15-18, wherein the metal-oxygen compound includes an oxometallate.
20. The anode according to any of embodiments 15-19, wherein the metal-oxygen compound includes scandium, titanium, vanadium, chromium, manganese, iron, cobalt, nickel, copper, yttrium, zinc, molybdenum, tungsten, silver, zirconium, tantalum, hafnium, tin, aluminum, indium, or niobium.
21. The anode according to any of embodiments 15-20, wherein the surface layer includes a first surface sublayer of the metal-oxygen compound interposed and a second surface sublayer including the silicate compound, the second surface sublayer overlaying the first surface sublayer.
22. The anode of embodiment 21, wherein the surface layer further includes a metal sublayer interposed between the electrically conductive layer and the first surface sublayer, wherein the metal sublayer includes a zero-valent metal.
23. The anode of embodiment 22, wherein the metal sublayer includes zinc, nickel, or a zinc-nickel alloy.
24. The anode according to any of embodiments 1-23, wherein the current collector includes a surface roughness Rₐ≥250 nm.
25. The anode according to any of embodiments 1-23, wherein the current collector includes a surface roughness Rₐ≥550 nm.
26. The anode of embodiment 25, wherein the current collector is characterized by pits formed by chemical roughening.
27. The anode according to any of embodiments 1-26, wherein the electrically conductive layer includes copper, nickel, titanium, stainless steel, or a combination thereof.
28. The anode according to any of embodiments 1-26, wherein the electrically conductive layer includes a copper alloy including copper, magnesium, silver, and phosphorous.
29. The anode according to any of embodiments 1-26, wherein the electrically conductive layer includes a copper alloy including copper, iron, and phosphorous.
30. The anode according to any of embodiments 1-26, wherein the electrically conductive layer includes a copper alloy including brass or bronze.
31. The anode according to any of embodiments 1-26, wherein the electrically conductive layer includes a copper alloy including copper, nickel, and silicon.
32. The anode according to any of embodiments 1-27, wherein the electrically conductive layer includes a mesh of electrically conductive carbon.
33. The anode according to any of embodiments 1-32, wherein the current collector further includes an insulating substrate, and wherein the electrically conductive layer overlays the insulating substrate.
34. The anode according to any of embodiments 1-33, wherein the electrically conductive layer or current collector is characterized by a tensile strength of at least 500 MPa.
35. The anode according to any of embodiments 1-33, wherein the electrically conductive layer or current collector is characterized by a tensile strength of greater than 600 MPa.
36. The anode according to any of embodiments 1-33, wherein the electrically conductive layer or current collector is characterized by a tensile strength of at least 700 MPa.
37. The anode according to any of embodiments 1-36, wherein the electrically conductive layer includes a metal foil.
38. The anode according to any of embodiments 1-37, wherein the lithium storage layer is substantially free of high aspect ratio lithium storage nanostructures.
39. The anode according to any of embodiments 1-38, wherein the lithium storage layer is a continuous porous lithium storage layer.
40. The anode according to any of embodiments 1-39, wherein the lithium storage layer includes a sub-stoichiometric nitride of silicon.
41. The anode according to any of embodiments 1-40, wherein the lithium storage layer includes a sub-stoichiometric oxide of silicon.
42. The anode according to any of embodiments 1-41, wherein the lithium storage layer includes at least 80 atomic % of amorphous silicon.
43. The anode of embodiment 42, wherein the density of the lithium storage layer is in a range of 1.1 to 2.25 g/cm³.
44. The anode according to any of embodiments 1-41, wherein the lithium storage layer includes up to 30% of nano-crystalline silicon.
45. The anode according to any of embodiments 1-44, wherein the lithium storage layer includes columns of silicon nanoparticle aggregates.
46. The anode according to any of embodiments 1-45, wherein the lithium storage layer further includes boron, phosphorous, sulfur, fluorine, aluminum, gallium, indium, arsenic, antimony, or bismuth, or a combination thereof.
47. The anode according to any of embodiments 1-46, wherein the lithium storage layer further includes a transition metal that is also present in the electrically conductive layer or surface layer.
48. The anode according to any of embodiments 1-47, wherein the lithium storage layer has an average thickness of at least 7 μm.
49. A lithium-ion battery including an anode according to any of embodiments 1-48 and a cathode.
50. The lithium-ion battery of embodiment 49, wherein the anode is at least partially prelithiated.
51. The lithium-ion battery of embodiment 49 or 50, wherein the battery is characterized in operation by an initial charge capacity of at least 2.0 mAh/cm² and is capable of an 80% SoH cycle life of at least 150 cycles at a charge rate of at least 1C and a discharge rate of at least C/3.
52. The lithium-ion battery of embodiment 51, wherein the initial charge capacity is at least 2.5 mAh/cm².
53. The lithium-ion battery of embodiment 49 or 50, wherein the battery is characterized in operation by an initial charge capacity of at least 1.7 mAh/cm² and is capable of an 80% SoH cycle life of at least 300 cycles at a charge rate of at least 1C and a discharge rate of at least C/3.
54. The lithium-ion battery according to any of embodiments 49-53, wherein the cathode includes nickel, manganese, and cobalt.
55. The lithium-ion battery according to any of embodiments 49-53, wherein the cathode includes sulfur, selenium, or both sulfur and selenium.
56. The lithium-ion battery according to any of embodiments 49-55, further including a solid-state electrolyte provided between the anode and cathode.
57. A lithium-ion battery including an anode and a cathode, wherein the anode is prepared in part by applying at least one electrochemical charge/discharge cycle to a non-cycled anode, the non-cycled anode including an anode according to any of embodiments 1-48.
58. A current collector for a lithium-ion energy storage device, the current collector including:
an electrically conductive layer; and
a surface layer including a silicate compound disposed over the electrically conductive layer.
59. The current collector of embodiment 58, wherein the electrically conductive layer includes roughening features.
60. The current collector of embodiment 59, wherein the roughening features include nanopillar features.
61. The current collector of embodiment 60, wherein the nanopillar features are characterized by a height H in a range of 0.4 μm to 5.0 μm, a maximum width Wm in a range of 0.4 μm to 3.0 μm, and an aspect ratio H/Wm in a range of 0.8 to 10.
62. The current collector of embodiment 60 or 61, wherein an average 10 μm by 10 μm surface of the electrically conductive layer includes at least 3 nanopillar features.
63. The current collector according to any of embodiments 59-69, wherein the roughening features include electrodeposited copper roughening features.
64. The current collector according to any of embodiments 58-63, wherein the silicate compound is in contact with the electrically conductive layer.
65. The current collector according to any of embodiments 58-64, wherein the silicate compound includes silicic acid.
66. The current collector according to any of embodiments 58-65, wherein the silicate compound includes a metal silicate.
67. The current collector of embodiment 66, wherein the metal silicate includes an alkali metal or an alkaline earth metal.
68. The current collector of embodiment 66 or 67, wherein the metal silicate includes a post transition metal.
69. The current collector according to any of embodiments 66-68, wherein the metal silicate includes a transition metal.
70. The current collector according to any of embodiments 58-69 wherein an areal density of silicon from the silicate compound in the surface layer is in a range of 0.5-30 mg/m².
71. The current collector according to any of embodiments 58-70, wherein the surface layer includes a metal-oxygen compound.
72. The current collector of embodiment 71, wherein the metal-oxygen compound includes a transition metal.
73. The current collector of embodiment 71 or 72 wherein the metal-oxygen compound includes a metal oxide.
74. The current collector according to any of embodiments 71-73, wherein the metal-oxygen compound includes a metal hydroxide.
75. The current collector according to any of embodiments 71-74, wherein the metal-oxygen compound includes an oxometallate.
76. The current collector according to any of embodiments 71-75, wherein the metal-oxygen compound includes scandium, titanium, vanadium, chromium, manganese, iron, cobalt, nickel, copper, yttrium, zinc, molybdenum, tungsten, silver, zirconium, tantalum, hafnium, tin, aluminum, indium, or niobium.
77. The current collector according to any of embodiments 71-76, wherein the surface layer includes a first surface sublayer of the metal-oxygen compound interposed and a second surface sublayer including the silicate compound, the second surface sublayer overlaying the first surface sublayer.
78. The current collector of embodiment 77, wherein the surface layer further includes a metal sublayer interposed between the electrically conductive layer and the first surface sublayer, wherein the metal sublayer includes a zero-valent metal.
79. The current collector of embodiment 78, wherein the metal sublayer includes zinc, nickel, or a zinc-nickel alloy.
80. The current collector according to any of embodiments 58-79, wherein the current collector is characterized by a surface roughness Rₐ≥250 nm.
81. The current collector according to any of embodiments 58-79, wherein the current collector is characterized by a surface roughness Rₐ≥550 nm.
82. The current collector of embodiment 81, wherein the current collector includes pits formed by chemical roughening.
83. The current collector according to any of embodiments 58-82, wherein the electrically conductive layer includes copper, nickel, titanium, stainless steel, or a combination thereof.
84. The current collector according to any of embodiments 58-82, wherein the electrically conductive layer includes a copper alloy including copper, magnesium, silver, and phosphorous.
85. The current collector according to any of embodiments 58-82, wherein the electrically conductive layer includes a copper alloy including copper, iron, and phosphorous.
86. The current collector according to any of embodiments 58-82, wherein the electrically conductive layer includes a copper alloy including brass or bronze.
87. The current collector according to any of embodiments 58-82, wherein the electrically conductive layer includes a copper alloy including copper, nickel, and silicon.
88. The current collector according to any of embodiments 58-83, wherein the electrically conductive layer includes a mesh of electrically conductive carbon.
89. The current collector according to any of embodiments 58-88, further including an insulating substrate, wherein the electrically conductive layer overlays the insulating substrate.
90. The current collector according to any of embodiments 58-89, wherein the electrically conductive layer or current collector is characterized by a tensile strength of at least 500 MPa.
91. The current collector according to any of embodiments 58-89, wherein the electrically conductive layer or current collector is characterized by a tensile strength of greater than 600 MPa.
92. The current collector according to any of embodiments 58-89, wherein the electrically conductive layer or current collector is characterized by a tensile strength of at least 700 MPa.
93. The current collector according to any of embodiments 58-92, wherein the electrically conductive layer includes a metal foil.
94. A method of making a current collector for use in an energy storage device, the method including:
providing a current collector precursor including at least an electrically conductive layer; and
contacting the current collector precursor with an aqueous silicate mixture including silicic acid or a silicate salt to form the current collector including a surface layer including a silicate compound.
95. The method of embodiment 94, further including, after contact with the silicate mixture, rinsing the current collector with water.
96. The method of embodiment 95, further including, after the rinsing, drying the current collector.
97. The method according to any of embodiments 94-96, wherein the silicate mixture has a pH of greater than or equal to 2.
98. The method according to any of embodiments 94-96, wherein the silicate mixture has a pH of greater than or equal to 5.
99. The method according to any of embodiments 94-96, wherein the silicate mixture has a pH in a range of 5 to 11.
100. The method according to any of embodiments 94-99, wherein the silicate mixture includes potassium silicate, sodium silicate, or a mixture thereof.
101. The method according to any of embodiments 94-100, wherein the contacting is performed for a period of at least 5 seconds.
102. The method according to any of embodiments 94-100, wherein the contacting is performed for a period in a range of 30 seconds to 5 minutes.
103. The method according to any of embodiments 94-102 wherein the silicate mixture is at a temperature in a range of 15° C. to 50° C.
104. The method according to any of embodiments 94-103, wherein the contacting includes agitation of the silicate mixture or the current collector precursor.
105. The method according to any of embodiments 94-104, wherein the current collector precursor includes a first surface sublayer including a metal-oxygen compound.
106. The method according to any of embodiments 94-104, further including, prior to the contacting, forming a first surface sublayer including a metal-oxygen compound over the electrically conductive layer.
107. The method of embodiment 105 or 106, wherein the surface layer includes a second surface sublayer disposed over the first surface sublayer, and wherein at least the second surface sublayer includes the silicate compound.
108. The method according to any of embodiments 105-107, wherein the metal-oxygen compound includes a transition metal.
109. The method according to any of embodiments 105-108, wherein the metal-oxygen compound includes a metal oxide.
110. The method according to any of embodiments 105-109, wherein the metal-oxygen compound includes a metal hydroxide.
111. The method according to any of embodiments 105-110, wherein the metal-oxygen compound includes an oxometallate.
112. The method according to any of embodiments 105-111, wherein the metal-oxygen compound includes scandium, titanium, vanadium, chromium, manganese, iron, cobalt, nickel, copper, yttrium, zinc, molybdenum, tungsten, silver, zirconium, tantalum, hafnium, tin, aluminum, indium, or niobium.
113. A method of making an anode for use in an energy storage device, the method including:
providing a current collector according to any of embodiments 58-93, or made by a method according to any of embodiments 94-112; and
forming, by a PVD process or by chemical vapor deposition using a silicon precursor gas, a lithium storage layer disposed over the current collector.
114. The method of embodiment 113, wherein the chemical vapor deposition includes a PECVD process.
115. The method of embodiment 114, wherein the PECVD process includes forming a capacitively-coupled plasma or an inductively-coupled plasma.
116. The method of embodiment 114, wherein the PECVD process includes a DC plasma source, an AC plasma source, an RF plasma source, a VHF plasma source, or a microwave plasma source.
117. The method of embodiment 114, wherein the PECVD process includes magnetron-assisted RF PECVD.
118. The method of embodiment 114, wherein the PECVD process includes expanding thermal plasma chemical vapor deposition.
119. The method of embodiment 114, wherein the PECVD process includes hollow cathode PECVD.
120. The method according to any of embodiments 113-119, wherein the lithium storage layer includes at least 40 atomic % silicon, germanium, or a combination thereof.
121. The method according to any of embodiments 113-120, wherein the lithium storage layer includes less than 10 atomic % carbon.
122. The method according to any of embodiments 113-121, wherein the lithium storage layer is substantially free of lithium storage nanostructures.
123. The method according to any of embodiments 113-122, wherein the lithium storage layer is a continuous porous lithium storage layer.
124. The method according to any of embodiments 113-123, wherein the lithium storage layer includes a sub-stoichiometric nitride of silicon.
125. The method according to any of embodiments 113-124, wherein the lithium storage layer includes a sub-stoichiometric oxide of silicon.
126. The method according to any of embodiments 113-125, wherein the lithium storage layer includes at least 80 atomic % of amorphous silicon.
127. The method of embodiment 126, wherein the density of the lithium storage layer is in a range of 1.1 to 2.25 g/cm³.
128. The method according to any of embodiments 113-125, wherein the lithium storage layer includes up to 30% of nano-crystalline silicon.
129. The method according to any of embodiments 113-128, wherein the lithium storage layer includes columns of silicon nanoparticle aggregates.
130. The method according to any of embodiments 113-129, wherein the lithium storage layer has an average thickness of at least 7 μm.
131. The method according to any of embodiments 113-130, wherein the silicon precursor gas is silane.
132. The method according to any of embodiments 113-132, further including doping the lithium storage layer with boron, phosphorous, sulfur, fluorine, aluminum, gallium, indium, arsenic, antimony, or bismuth, or a combination thereof.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

We claim:

1. An anode for an energy storage device, the anode comprising:
a current collector comprising an electrically conductive layer and a surface layer comprising a silicate compound disposed over the electrically conductive layer; and
a lithium storage layer overlaying and in contact with the surface layer,
wherein the lithium storage layer comprises at least 40 atomic % silicon, germanium, or a combination thereof.

2. The anode of claim 1, wherein the lithium storage layer is substantially free of carbon-based binders.

3. The anode of claim 1, wherein the electrically conductive layer comprises roughening features.

4. The anode of claim 3, wherein the roughening features comprise nanopillar features.

5. The anode of claim 4, wherein the nanopillar features are characterized by a height H in a range of 0.4 μm to 5.0 μm, a maximum width W in a range of 0.4 μm to 3.0 μm, and an aspect ratio H/W in a range of 0.8 to 10.

6. The anode of claim 4, wherein an average 10 μm by 10 μm surface of the electrically conductive layer comprises at least 3 nanopillar features.

7. The anode of claim 3, wherein the roughening features comprise electrodeposited copper roughening features.

8. The anode of claim 1, wherein the silicate compound is in contact with the electrically conductive layer.

9. The anode of claim 1, wherein the silicate compound comprises silicic acid.

10. The anode of claim 1, wherein the silicate compound comprises a metal silicate.

11. The anode of claim 10, wherein the metal silicate comprises an alkali metal or an alkaline earth metal.

12. The anode of claim 10, wherein the metal silicate comprises a post transition metal.

13. The anode of claim 10, wherein the metal silicate comprises a transition metal.

14. The anode of claim 1, wherein an areal density of silicon from the silicate compound in the surface layer is in a range of 0.5-30 mg/m².

15. The anode of claim 1, wherein the surface layer further comprises a metal-oxygen compound.

16. The anode of claim 15, wherein the metal-oxygen compound comprises a transition metal.

17. The anode of claim 15, wherein the metal-oxygen compound comprises a metal oxide.

18. The anode of claim 15, wherein the metal-oxygen compound comprises a metal hydroxide.

19. The anode of claim 15, wherein the metal-oxygen compound comprises an oxometallate.

20. The anode of claim 15, wherein the metal-oxygen compound comprises scandium, titanium, vanadium, chromium, manganese, iron, cobalt, nickel, copper, yttrium, zinc, molybdenum, tungsten, silver, zirconium, tantalum, hafnium, tin, aluminum, indium, or niobium.

21. The anode of claim 15, wherein the surface layer comprises a first surface sublayer of the metal-oxygen compound interposed and a second surface sublayer comprising the silicate compound, the second surface sublayer overlaying the first surface sublayer.

22. The anode of claim 21, wherein the surface layer further comprises a metal sublayer interposed between the electrically conductive layer and the first surface sublayer, wherein the metal sublayer comprises a zero-valent metal.

23. The anode of claim 22, wherein the metal sublayer comprises zinc, nickel, or a zinc-nickel alloy.

24. The anode of claim 1, wherein the current collector comprises a surface roughness Rₐ≥250 nm.

25. The anode of claim 1, wherein the current collector comprises a surface roughness Rₐ≥550 nm.

26. The anode of claim 25, wherein the current collector is characterized by pits formed by chemical roughening.

27. The anode of claim 1, wherein the electrically conductive layer comprises copper, nickel, titanium, stainless steel, or a combination thereof.

28. The anode of claim 1, wherein the electrically conductive layer comprises a copper alloy comprising copper, magnesium, silver, and phosphorous.

29. The anode of claim 1, wherein the electrically conductive layer comprises a copper alloy comprising copper, iron, and phosphorous.

30. The anode of claim 1, wherein the electrically conductive layer comprises a copper alloy comprising brass or bronze.

31. The anode of claim 1, wherein the electrically conductive layer comprises a copper alloy comprising copper, nickel, and silicon.

32. The anode of claim 1, wherein the electrically conductive layer comprises a mesh of electrically conductive carbon.

33. The anode of claim 1, wherein the current collector further comprises an insulating substrate, and wherein the electrically conductive layer overlays the insulating substrate.

34. The anode of claim 1, wherein the electrically conductive layer or current collector is characterized by a tensile strength of at least 500 MPa.

35. The anode of claim 1, wherein the electrically conductive layer or current collector is characterized by a tensile strength of greater than 600 MPa.

36. The anode of claim 1, wherein the electrically conductive layer or current collector is characterized by a tensile strength of at least 700 MPa.

37. The anode of claim 1, wherein the electrically conductive layer comprises a metal foil.

38. The anode of claim 1, wherein the lithium storage layer is substantially free of high aspect ratio lithium storage nanostructures.

39. The anode of claim 1, wherein the lithium storage layer is a continuous porous lithium storage layer.

40. The anode of claim 1, wherein the lithium storage layer comprises a sub-stoichiometric nitride of silicon.

41. The anode of claim 1, wherein the lithium storage layer comprises a sub-stoichiometric oxide of silicon.

42. The anode of claim 1, wherein the lithium storage layer comprises at least 80 atomic % of amorphous silicon.

43. The anode of claim 42, wherein the density of the lithium storage layer is in a range of 1.1 to 2.25 g/cm³.

44. The anode of claim 1, wherein the lithium storage layer comprises up to 30% of nano-crystalline silicon.

45. The anode of claim 1, wherein the lithium storage layer comprises columns of silicon nanoparticle aggregates.

46. The anode of claim 1, wherein the lithium storage layer further comprises boron, phosphorous, sulfur, fluorine, aluminum, gallium, indium, arsenic, antimony, or bismuth, or a combination thereof.

47. The anode of claim 1, wherein the lithium storage layer further comprises a transition metal that is also present in the electrically conductive layer or surface layer.

48. The anode of claim 1, wherein the lithium storage layer has an average thickness of at least 7 μm.

49. A lithium-ion battery comprising the anode of claim 1 and a cathode.

50. The lithium-ion battery of claim 49, wherein the anode is at least partially prelithiated.

51. The lithium-ion battery of claim 49, wherein the battery is characterized in operation by an initial charge capacity of at least 2.0 mAh/cm² and is capable of an 80% SoH cycle life of at least 150 cycles at a charge rate of at least 1C and a discharge rate of at least C/3.

52. The lithium-ion battery of claim 51, wherein the initial charge capacity is at least 2.5 mAh/cm².

53. The lithium-ion battery of claim 49, wherein the battery is characterized in operation by an initial charge capacity of at least 1.7 mAh/cm² and is capable of an 80% SoH cycle life of at least 300 cycles at a charge rate of at least 1C and a discharge rate of at least C/3.

54. The lithium-ion battery of claim 49, wherein the cathode comprises nickel, manganese, and cobalt.

55. The lithium-ion battery of claim 49, wherein the cathode comprises sulfur, selenium, or both sulfur and selenium.

56. The lithium-ion battery of claim 49, further comprising a solid-state electrolyte provided between the anode and cathode.

57. A lithium-ion battery comprising an anode and a cathode, wherein the anode is prepared in part by applying at least one electrochemical charge/discharge cycle to a non-cycled anode, the non-cycled anode comprising the anode of claim 1.
